(19) United States
(12) Patent Application Publication
(10) Pub. No.: US 2015/0298164 A1
(43) Pub. Date: Oct. 22, 2015

(54) CARBON NANOTUBE FILMS PROCESSED FROM STRONG ACID SOLUTIONS AND METHODS FOR PRODUCTION THEREOF

(71) Applicants: Matteo Pasquali, Houston, TX (US); Wing Kui Anson Ma, Storrs, CT (US); Natnael Behabtu, Houston, TX (US); Mainak Majumder, Wheeler's Hill (AU); Jaewook Nam, Houston, TX (US); Francesca Mirri, Houston, TX (US); Tien Yi Theresa Hsu Whiting, Doylestown, OH (US)

(72) Inventors: Matteo Pasquali, Houston, TX (US); Wing Kui Anson Ma, Storrs, CT (US); Natnael Behabtu, Houston, TX (US); Mainak Majumder, Wheeler's Hill (AU); Jaewook Nam, Houston, TX (US); Francesca Mirri, Houston, TX (US); Tien Yi Theresa Hsu Whiting, Doylestown, OH (US)

(73) Assignee: William Marsh Rice University, Houston, TX (US)

(21) Appl. No.: 14/344,809

(22) PCT Filed: Sep. 13, 2012
(86) PCT No.: PCT/US12/55183

§ 371 Date: May 15, 2015

Related U.S. Application Data
(60) Provisional application No. 61/533,888, filed on Sep. 13, 2011.

(51) Int. Cl. B05D 1/18; B05D 1/02; C01B 31/00; B05D 3/06; B05D 3/02; C01B 31/02; G02F 1/1333; B05D 1/30

(52) U.S. Cl. CPC B05D 1/18; G02F 1/13338; B05D 1/02; B05D 1/305; B05D 3/06; B05D 3/0272; C01B 31/0273; C01B 31/00; Y10S 977/75; Y10S 977/892; Y10S 977/952; B82Y 30/00

(57) ABSTRACT

In some embodiments, the present disclosure provides methods for fabricating carbon nanotube films. Such methods generally comprise: (i) suspending carbon nanotubes in a superacid (e.g. chloro sulfonic acid) to form a dispersed carbon nanotube-superacid solution, wherein the carbon nanotubes have substantially exposed sidewalls in the carbon nanotube-superacid solution; (ii) applying the dispersed carbon nanotube-superacid solution onto a surface to form a carbon nanotube film; and (iii) removing the superacid. Desirably, such methods occur without the utilization of carbon nanotube wrapping molecules or sonication. Further embodiments of the present disclosure pertain to carbon nanotube films that are fabricated in accordance with the methods of the present disclosure. Such carbon nanotube films comprise a plurality of carbon nanotubes that are dispersed and individualized. Additional embodiments of the present disclosure pertain to macroscopic objects comprising the carbon nanotube films made in accordance with the methods of the present disclosure described supra.

### CROSS REFERENCE TO RELATED APPLICATIONS

This application claims priority to U.S. Provisional Patent Application No. 61/533,888, filed on Sep. 13, 2011, the entirety of which is incorporated herein by reference.

### STATEMENT REGARDING FEDERALLY SPONSORED RESEARCH

This invention was made with government support under Grant Nos. FA9550-09-1-0590; FA9550-06-1-0207; FA8650-07-2-5061; and FA8650-05-D-5807, all awarded by the U.S. Department of Defense. The government has certain rights in the invention.

### BACKGROUND

A large number of applications have been envisioned for carbon nanotubes. However, their limited solubility in ordinary solvents creates great difficulty in processing them into macroscopic functional materials (such as fibers, films, and composites). The limited solubility of carbon nanotubes also impedes the development of multifunctional meta materials requiring precise spatial ordering.

Furthermore, current methods and systems of providing immobilized carbon nanotubes suffer from various limitations and are not suitable for large-scale fabrication of thin films. Such limitations include inability to produce one single electronic type carbon nanotubes in large quantities. Such limitations also include processing steps that adversely affect the mechanical and electrical performance of the films. Therefore, there is currently a need to develop new scalable processing methods and systems for producing carbon nanotube films with controlled morphology and optimal performance.

### BRIEF SUMMARY

In some embodiments, the present disclosure provides methods for fabricating carbon nanotube films. Such methods generally comprise: (i) suspending carbon nanotubes in a superacid (e.g. chlorosulfonic acid) to form a dispersed carbon nanotube-superacid solution, wherein the carbon nanotubes have substantially exposed sidewalls in the superacid solution; (ii) applying the dispersed carbon nanotube-superacid solution onto a surface to form a carbon nanotube film; and (iii) removing the superacid. Desirably, such methods occur without the utilization of carbon nanotube wrapping molecules (e.g., surfactants, soluble silicon oxide molecules, and/or oligonucleotides) or sonication. In additional embodiments, the methods of the present disclosure may further comprise: washing the carbon nanotube film with diethyl ether followed by washing with water.

Further embodiments of the present disclosure pertain to carbon nanotube films comprising a plurality of carbon nanotubes, where the carbon nanotubes are dispersed and individualized. In some embodiments, such carbon nanotube films are made in accordance with the methods of the present disclosure and do not require the utilization of carbon nanotube wrapping molecules (e.g., surfactants) or sonication. Accordingly, in some embodiments, the immobilized carbon nanotubes in the carbon nanotube films are not associated with any carbon nanotube wrapping molecules. In some embodiments, the carbon nanotube films of the present disclosure may be freestanding. In some embodiments, the carbon nanotube films of the present disclosure may be immobilized onto a surface.

Additional embodiments of the present disclosure pertain to macroscopic objects comprising the carbon nanotube films made in accordance with the methods of the present disclosure described supra. As set forth in more detail herein, the methods and systems of the present disclosure provide numerous improvements in fabricating carbon nanotube films with controlled morphology and optimal performance on various surfaces. In addition, the methods and systems of the present disclosure provide various macroscopic applications, including use of the carbon nanotube films made by the methods of the present disclosure as films for touch screen applications.

### BRIEF DESCRIPTION OF THE FIGURES

FIGS. 1A-1B show transmitted light micrographs of dried films dip coated from 0.1% (FIG. 1A) and 0.2% (FIG. 1B) isotropic solutions of single-wall carbon nanotubes (SWNTs) in chlorosulfonic acid.

FIG. 1C shows a scanning electron microscopy (SEM) image of the film shown in FIG. 1B.

FIGS. 1D-1F show transmitted light micrographs of dried films dip coated from biphasic solutions: 0.5% (FIG. 1D), 0.7% (FIG. 1E), and 1% (FIG. 1F), respectively.

FIG. 2A depicts a schematic illustration of a film formation process consisting of three main steps: (1) Self-assembly: SWNTs are dissolved in chlorosulfonic acid creating a biphasic solution which contains SWNT liquid crystals and individually dispersed (isotropic) SWNTs; (2) Directed assembly: Dip coating is then applied to produce a wet film containing elongated and aligned liquid crystals; and (3) Self-assembly: by removing the acid solvent, the pre-aligned liquid crystals serve as the nucleating sites for whisker-like crystallites.

FIG. 2B shows experimental setup for dip coating the SWNT-chlorosulfonic acid solutions. Both the dip coating and acid removal steps were carried out inside a glove bag constantly purged with anhydrous Argon to avoid moisture contamination.

FIGS. 3A-3B show optical micrographs of the dip coating solution containing 0.7% (by vol.) SWNTs in chlorosulfonic acid, imaged using transmitted light (FIG. 3A) and transmitted light with cross-polarizers (FIG. 3B). The solution sample was sealed between a glass microscope slide and a cover slip using aluminum tape.

FIGS. 3C-3D show optical micrographs of the corresponding dip coated films (after acid removal) imaged under transmitted light (FIG. 3C) and transmitted light with cross-polarizers (FIG. 3D). The dip coating direction was horizontal, as indicated.

FIGS. 4A-4B show SEM image (FIG. 4A) and transmission electron microscopy (TEM) image (FIG. 4B) of a dried SWNT film produced from the 0.5% (by vol.) SWNT-chlorosulfonic acid solution.

FIG. 4C shows a SWNT whisker with a diameter of 100 nm protruding out of a random SWNT network.

FIGS. 4D-4F show high magnification image of a SWNT whisker showing high degree of SWNT alignment (FIG. 4D), the electron diffraction pattern of the same whisker (FIG. 4E), and central line profile of a SWNT whisker, indicating triangular lattice packing (FIG. 4F).

FIGS. 5A-5E show shear rate profile for different concentrations of dip coating solutions calculated from the 2-D flow analysis: 0.2% (FIG. 5A), 0.5% (FIG. 5B), 0.7% (FIG. 5C), and 1% SWNT in chlorosulfonic acid (FIG. 5D). The dip coating solutions are assumed as a power-law fluid. The values of maximum shear rate (close to the glass substrate), average shear rate, and residence time are given for each dip coating solution. The streamline plot showing the liquid entrainment area (Ae) is illustrated in FIG. 5E.

FIGS. 6A-6B show dry film thickness (hdry) of films dip coated from different concentrations of SWNT solutions measured by AFM and profilometer (FIG. 6A). The substrate withdrawal speed is 1 mm/s. For the profilometer measurements, the error bar of each data point represents the standard deviation of nine measurements (three films dip coated from the same solution and three measurements are carried out at various locations on each film). For AFM measurements, the error bar represents three measurements carried out at different locations of the same film. Film thickness as a function of substrate withdrawal speed for three different concentrations (CSWNT) of SWNT in chlorosulfonic acid is shown in FIG. 6B. The lines are power law fit.

FIGS. 7A-7E depicts schematics of a dip coating process: homogeneous solution of CNTs in chlorosulfonic acid (FIG. 7A); withdrawal step and formation of the film on the glass slide by controlling the lifting speed (FIG. 7B); coagulation and washing steps for the removal of CSA using a chloroform bath or a series of baths of chloroform coagulation followed by diethyl ether and water washes (FIG. 7C); dip coating set-up (FIG. 7D); and 90% transparent thin film obtained by dip coating from double-wall carbon nanotube (DWNT)-CSA solutions (FIG. 7E).

FIGS. 8A-8B show micrographs of carbon nanotube films. Transmitted light micrographs of SWNT (top) and DWNT (bottom) films fabricated from a 1000 ppm solution at different withdrawal speeds are shown in FIG. 8A. The scale bar is equal to 50 μm and the red arrow represents the coating direction. Polarized light micrographs of SWNT (top) and DWNT (bottom) films fabricated from 1000 ppm solution at different withdrawal speeds (1 mm/min to 3 mm/min) are shown in FIG. 8B. SWNT films show isotropic orientation at low shear rate. Slightly ordered structures in the coating direction can be seen at 3 mm/min coating speed. DWNT films show a preferential orientation in the coating direction due to the liquid crystalline domains in the 1000 ppm CSA solution. These domains are stretched during dip coating and yield ordered CNT bundles in the film (bright regions). The films were coagulated with chloroform. The scale bar is equal to 50 μm. The red and white arrows represent the coating direction and the cross polars, respectively.

FIGS. 9A-9B show SEM images (FIG. 9A) and transmission electron microscopy (TEM) images (FIG. 9B) of the films transferred onto TEM grids. Presence of an isotropic network of individual CNTs and bundles are likely responsible for the isotropic electrical properties of the films. The films were chloroform coagulated before being detached from the glass slide with a water bath.

FIGS. 10A-10B shows transmittance at the wavelength of 550 nm with respect to the withdrawal speed at different fixed concentrations of DWNT in CSA (FIG. 10A). Each value of transmittance is an average of 3 films fabricated with the same dip-coating parameters. Transmittance versus sheet resistance for films obtained by DWNTs using different acid removal processes is shown in FIG. 10B. Films produced with direct CSA evaporation and simple chloroform coagulation showed lower sheet resistance values most likely due to the presence of sulfuric acid (see XPS data in FIG. 16). On the other hand, higher values of sheet resistance were found for films coagulated with chloroform and washed with diethyl ether and water due to the near complete removal of sulfuric acid.

FIG. 11 shows transmittance versus sheet resistance for films obtained by DWNTs and SWNTs using simple chloroform coagulation. Films obtained by SWNTs showed higher sheet resistance (from about 4 to 10 times higher) than DWNT films. The length of the CNTs plays a fundamental role in the film conductivity as demonstrated in previous literature. Each sheet resistance value represents the average of at least 5 random points in the film.

FIGS. 12A-12B show transmittance versus sheet resistance for films obtained by dip coating in the recent literature (FIG. 12A), and transmittance versus sheet resistance of the best films obtained in literature up to date for various coating methods (FIG. 12B). The values of sheet resistance reported represent the average of at least 5 random points in the film and were obtained for DWNT films with the three techniques used.

FIG. 13 shows micrographs of 1000 ppm solutions of DWNT (left) and SWNT (right) in CSA under cross-polarized light in 1 mm thick glass capillaries. The DWNT solution shows strong birefringence, indicating the presence of liquid crystals. The SWNT solution is isotropic, as it shows almost no birefringence. The small bright dots may be small liquid crystalline domains formed by the longest SWNTs in the polydisperse sample. The capillaries were filled by capillary forces in a low-humidity glovebox and then flame sealed to avoid the ingress of moisture.

FIG. 14 shows viscosity versus shear rate for DWNT solutions at 1000, 2000 and 3000 ppm concentrations. The solutions shear thin as power-law fluids with apparent viscosity ηₐ=K\dot{γ}ⁿ⁻ⁱ, where \dot{γ} is the shear rate and K is the consistency index. The power law exponent n can be obtained from the slope of the curves as shown in the figure. Data were collected using a AR2000eX rheometer with a concentric cylinder (Couette) geometry. The rheometer was enclosed in a glovebox to protect the sample from moisture.

FIG. 15 shows logarithmic plot of −lnT (where T is the film transmittance) versus lifting speed u for films obtained at different concentrations and withdrawal speed. The transmittance at each concentration and lifting speed was calculated by averaging three different films made under the same dip coating conditions. The slope of ⅔ represents the theoretical value for Newtonian fluids. The slope of 0.43, 0.42, and 0.41 are the slopes obtained from the Gutfinger and Tallmadge model for 3000, 2000, and 1000 ppm solutions, respectively.

FIG. 16 shows XPS spectra for films made using methods (1), (2) and (3). Sulfur peaks appear clearly in films coagulated with chloroform (method (1)) and vacuum dried-diethyl ether washed films (method (3)) (about 9.1 and 2.3 atomic % of sulfur present using method (1) and (3), respectively). The presence of sulfur is due to the incomplete sulfuric acid removal. On the other hand, water washed films (method (2)) removed the presence of sulfur peaks (<0.1 atomic % sulfur content). The species % content was estimated after the subtraction of the signal given by the bare glass slide (Si and Na peaks come from the glass support as well as most of the oxygen that showed approximately a ratio of 2.6:1 with Si based on a control experiment with a clean glass slide) for an average of five random points along each film. Data were collected with PHI quantera XPS.

FIG. 17 shows electrical stability in time for films made using three different CSA removal techniques: simple chloroform coagulation (1); chloroform coagulation followed by diethyl ether and water wash (2); and vacuum oven drying and diethyl ether wash (3). On the left, sheet resistance versus time is shown. On the right, sheet resistance relative to the initial sheet resistance (Rₛ/Rₛₒ) versus time is shown. Films obtained with method (1) were unstable in time (increase of 66.8% after 9 days) compared to method (2) and (3) that exhibited higher stability. In particular, using method (3), 91.4% transmittance film showed an increase in sheet resistance of 13.6%, while using method (2), 93% transmittance film and 77.5% transmittance film showed an increase of 0.9% and of 8.6%, respectively. Each point represents the average of five random spots on the film. The error bars indicate the standard deviations.

FIG. 18 shows the effect of current on sheet resistance Rₛ(t) (normalized by its initial value Rₛₒ) for films with ˜90% transmittance. A current of 1 mA was applied for 180 min through the electrodes of a four-point probe. The film produced by chloroform coagulation followed by diethyl ether and water wash vacuum (method (2)) showed no significant change. Films produced using simple chloroform coagulation (method (1)) and vacuum oven drying and diethyl ether wash (method (3)) showed a continuous increase in sheet resistance that plateaued after ˜30 min (˜40% increase for film (1) and ˜20% increase for film (3)). The current was removed at t=180 min, and Rs was monitored in time (by imposing current for a few seconds every ˜5-60 min). The sheet resistance recovered slowly and attained its initial value overnight, demonstrating that this phenomenon is reversible and is most likely caused by the separation of H⁺ and SO₄²⁻ ions at the electrodes of the four-point probe.

### DETAILED DESCRIPTION

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The development of new materials where carbon nanotubes are dispersed and individualized is desirable for the development of large-scale functional materials with novel properties (such as improved sensors). Since their discovery, carbon nanotubes (CNTs) have received increasing attention due to their outstanding mechanical, thermal and electrical properties. In particular, research has focused on realizing in macroscopic objects the properties of single CNT molecules. For instance, CNTs have been formed into neat fibers as well as thin conductive films. In particular, transparent CNT films could replace indium tin oxide (ITO) because of their flexibility, resistance to flexural fatigue, and ease of manufacturing compared to the brittle ITO films, which must be fabricated by sputtering at low pressure or chemical vapor deposition at high temperature. Moreover, CNT films may enable new applications in flexible electronics, because of their ability to bend repeatedly without cracking.

Transparent conductive CNT films have been fabricated using a variety of processes that include dry and wet methods. The dry fabrication route consists of drawing films directly from CNT arrays. Wet methods consist of dispersing the CNTs in a liquid, and then fabricating films from the liquid phase. Multiple approaches have been used for wet method thin film assembly, including vacuum filtration, drop casting, spin coating, rod coating, spray coating, and dip coating.

Although the fluid phase approach is more conducive to industrial and commercial production, just a few of the above techniques (rod, spray, and dip coating) are suitable for scale up and can be adapted to high-throughput coating processes such as slot, knife, slide, and roll coating. Furthermore, most liquid phase film fabrication methods rely on functionalization or the use of surfactants and sonication to form CNT dispersions. However, functionalization degrades the electrical properties of the CNTs, disrupting the sp² bonds and yielding low film conductivity. Moreover, surfactant stabilization relies on sonication, which shortens the CNTs. Sonication can also degrade film conductivity because it raises the number of CNT-CNT junctions per unit area of the film.

Furthermore, good surfactants adsorb strongly on CNTs, and their removal from the film is difficult. In addition, surfactant residues in the final film increase sheet resistance. Therefore, a solvent able to effectively disperse CNTs without damaging the ultimate properties of the films is needed.

Chlorosulfonic acid (CSA) is a viable solution, and it circumvents the potentially detrimental effects of sonication, functionalization and use of surfactants. CSA-CNT solutions have already been used for SWNT film fabrication. However, these techniques were not scalable or yielded poor film properties. Hence, the assembly of CNTs into large-scale functional materials involves addressing important challenges, including organization, alignment and individualization.

Presently, overcoming the aforementioned challenges is one of the main goals of carbon nanotechnology. Thus, the present invention aims to address these challenges.

Accordingly, one aspect of the present disclosure that will be disclosed in more detail herein provides methods for the production of high-performance thin transparent conductive CNT films from superacids (e.g., CSA solutions) by various methods (e.g., dip-coating). This is followed by superacid removal through a series of steps (e.g., coagulation or drying, followed by washing) that stabilizes the films and preserves the film structure after fabrication. This process is scalable. Furthermore, no sonication is needed. Therefore, in some embodiments, such processes can produce films consisting of ˜10 μm long CNTs with optimal electrical properties.

The methods of the present disclosure also have several advantages over prior art methods: Firstly, the films are naturally acid-doped and have a higher conductivity. Secondly, this method requires no sonication, making it highly adaptable for long single-wall carbon nanotubes (SWNTs). Thirdly, by modulating the interaction between CNTs through the use of different acid mixtures with varying acid strength, one can further tailor the film structure and properties. For instance, in various embodiments, film morphology and the optical and electrical properties of the film can be controlled by the coating speed, superacid concentration, and level of doping. The level of doping can also be controlled by post-processing, such as washing and heating at high temperatures.

In some embodiments, the present disclosure provides methods of making thin CNT films (e.g., CNT films with thicknesses in tens of nanometers) from isotropic solutions of CNTs. In some embodiments, the present disclosure pertains to the creation of whisker-like crystallite structures from biphasic solutions of carbon nanotubes. In some embodiments, these whisker-like structures include SWNTs that are highly aligned and closely packed in a crystalline manner. In some embodiments, the SWNTs in the whisker-like structures have a maximum width of about 100 nm, and a typical length of about 10-20 μm. In some embodiments, these whiskers are macroscopically aligned in the dip coating direction and are interspersed with an isotropic SWNT network. In various embodiments, the thickness of the SWNT films can be controlled through the dip coating solution formulation and the substrate withdrawal speed. Notably, the film-formation method closely resembles the processing of liquid crystalline polymers into films with aligned crystalline structures, confirming further that, with the right solvent, polymer processing techniques can be readily adapted to CNT material processing

Another aspect of the present disclosure pertains to a carbon nanotube film comprising a plurality of carbon nanotubes, where the carbon nanotubes are dispersed and individualized. Yet, another aspect of the present disclosure pertains to macroscopic objects comprising the carbon nanotube film made in accordance with the methods of the present disclosure described supra.

The present disclosure provides a scalable method, by which carbon nanotubes may be processed into films with controlled morphology and optimal performance. In various embodiments, the methods of the present disclosure require no sonication or chemical functionalization. Thus, the methods of the present disclosure can allow for the preservation of carbon nanotube length and intrinsic electrical properties.

The aforementioned embodiments will be discussed in more detail herein. Various aspects of the methods and systems of the present disclosure will also be discussed with more elaboration herein as specific and non-limiting examples.

Carbon Nanotubes

The methods and systems of the present disclosure may utilize various types of carbon nanotubes. By way of background, carbon nanotubes are nanoscale carbon structures comprising rolled up graphene sheets. For instance, SWNTs comprise a single such graphene cylinder, while multi-walled carbon nanotubes (MWNTs) are made of two or more concentric graphene layers. Since their initial preparation in 1993, SWNTs have been studied extensively due to their unique mechanical, optical, electronic, and other properties. For example, the remarkable tensile strength of SWNTs has resulted in their use in reinforced fibers and polymer nanocomposites.

In some embodiments of the present disclosure, carbon nanotubes used in conjunction with the methods and systems of the present disclosure may include, without limitation, single-walled carbon nanotubes (SWNTs), double-walled carbon nanotubes (DWNTs), multi-walled carbon nanotubes (MWNTs), small diameter carbon nanotubes (i.e., carbon nanotubes with diameters equal or less than about 3 nm), ultra-short carbon nanotubes, and combinations thereof. In some embodiments, the carbon nanotubes used in conjunction with the methods and systems of the present disclosure may include pristine carbon nanotubes, such as unmodified carbon nanotubes made by the HiPCO method.

In some embodiments, the carbon nanotubes used in conjunction with the methods and systems of the present disclosure may include long carbon nanotubes. In more specific embodiments, the long carbon nanotubes may have lengths that range from about 1 μm to about 100 μm, or from about 5 μm to about 20 μm.

Other suitable carbon nanotubes for use with various embodiments of the present disclosure may include functionalized carbon nanotubes. Such carbon nanotubes may be functionalized by various functional groups, including but not limited to aryl groups, alkyl groups, halogen groups, aromatic groups, carboxyl groups, and the like. In more specific embodiments, the carbon nanotubes may include SWNTs, such as pristine SWNTs.

Superacids

The methods and systems of the present disclosure may also utilize various types of superacids. Superacids generally refer to acids that have an acidity greater than that of 100% pure sulfuric acid. Non-limiting examples of superacids suitable for use in connection with the methods and systems of the present disclosure include fuming sulfuric acid, oleum, chlorosulfonic acid, triflic acid, fluorosulfonic acid, trifluoromethanesulfonic acid, perchloric acid, anhydrous hydrogen fluoride, and combinations thereof.

In some embodiments, superacids may also comprise Bronsted acid/Lewis acid complexes. Such complexes can include, without limitation, HSO₃F/SbF₅, HF/SbF₅, HCl/AlCl₃, HF/BF₃, and combinations thereof. In more specific embodiments, the superacid used is chlorosulfonic acid (CSA). Other suitable superacids may also be envisioned.

Without being bound by theory, it is envisioned that superacids facilitate the dispersion or dissolution of CNTs by surrounding the CNTs with a double layer of protons and counterions. See, e.g., Davis et al., Macromolecules, 2004, 37, 154. It is likely that this proposed intercalation of ions is at least partially responsible for the debundling of the CNTs before immobilization onto a surface.

Surfaces

CNTs may be immobilized onto various surfaces (also referred to as substrates) in accordance with the methods and systems of the present disclosure. In some embodiments, the surfaces comprise mesoporous and/or nonporous materials. Suitable surface materials may include, without limitation, silicates, aluminosilicates, silicon oxides, zeolites, glass, and quartz. In more specific embodiments, the surface may comprise NaY zeolites (e.g., ultrastabilized NaY zeolites), USY zeolites (e.g., ultrastabilized zeolite Y), and the like.

In some embodiments, the surface may comprise a polymeric material. In some embodiments, the surface may include one or more polymers. Suitable polymers on a surface may include, without limitation, polyethylenes, polyethylene terephthalate, polypropylenes, polystyrenes, polyethylene furanoate, polycyclohexylenedimethylene terephthalate, polytetrafluoroethylenes, fluorinated ethylene propylene, perfluoroalkoxy, polyamides, polyimides, epoxies, aramids, polyacrylonitriles, polyvinyl alcohols, polybutadienes, poly acrylic acids, poly lactic acids, poly methacrylic acids, polymethyl methacrylates, polyurethanes, poly vinyl chlorides, polydimethyloxanes, polycarbonates, related materials, and combinations thereof.

In some embodiments, the surface may comprise a Mobile Composition of Matter surface (MCM), such as MCM-41. Specific examples may include, without limitation, MCM-41-A and MCM-41-S.

The surfaces of the present disclosure may also have various forms, shapes, and structures. For instance, in some embodiments, the surface may be a flat surface. In other embodiments, the surface may have a circular shape. In further embodiments, the surface may comprise glass beads and/or spheres (e.g., silicon oxide spheres). In some embodiments, the surface may be patterned, grooved, or otherwise non-planar. In yet further embodiments, the surface can be patterned by ridges, grooves, or other patterns. Other suitable surfaces can also be envisioned.

Methods

As set forth previously, various embodiments of the present disclosure pertain to methods of fabricating carbon nanotube films. Such methods generally comprise: (i) suspending carbon nanotubes in a superacid to form a dispersed carbon nanotube-superacid solution, wherein the carbon nanotubes have substantially exposed sidewalls in the superacid solution; (ii) applying the dispersed carbon nanotube-superacid solution onto a surface to form a carbon nanotube film on the surface; and (iii) removing the superacid. The aforementioned steps can occur under various conditions.

In some embodiments, the formed carbon nanotube-superacid solution may be an isotropic solution. In some embodiments, the isotropic solution comprises individually dispersed carbon nanotubes. In some embodiments, the formed carbon nanotube-superacid solution may be a biphasic solution. In some embodiments, the biphasic solution comprises a mixture of both individually dispersed carbon nanotubes and liquid crystals of aligned carbon nanotubes. In some embodiments, the carbon nanotube superacid solution is in liquid crystalline form. In some embodiments, various polymeric or non-polymeric components may be added to the carbon nanotube-superacid solution for optimal mixing. Such components may also be added after mixing to create composite films with interspersed segregated or multilayered structures.

In some preferred embodiments, the aforementioned steps of the present disclosure occur without utilization of carbon nanotube wrapping molecules or chemical functionalization. Such carbon nanotube wrapping molecules may include surfactants (such as SDS), oligonucleotides, and soluble silicon oxide molecules. In some preferred embodiments, the methods of the present disclosure may occur without utilization of any sonication steps. In some embodiments, the methods of the present disclosure may occur without the utilization of any carbon nanotube wrapping molecules, chemical functionalization, or sonication steps.

The exclusion of carbon nanotube wrapping molecules and sonication steps from the methods of the present disclosure provide various advantages. For instance, the exclusion of such steps can maintain the electronic properties of the immobilized carbon nanotubes and make this method highly adaptable to long SWNTS. Further, surfactant stabilization relies on sonication, which shortens the CNTs. This also degrades film conductivity because it raises the number of CNT-CNT junctions per unit area of the film. Moreover, good surfactants adsorb strongly on CNTs. Thus, their removal from the film is difficult. Furthermore, surfactant residues in the final film increase sheet resistance

In some embodiments, other high performance materials that are also soluble in acids may be added to the carbon nanotube-superacid solution for molecular-level mixing. Such materials may include, without limitations, graphenes, graphite, fullerenes, boron nitride nanotubes, hexagonal boron nitride, and combinations thereof. In related embodiments, a new class of composite materials may be created by: (1) mixing and varying the ratio of the added components in superacids, and/or (ii) performing multiple coatings to create structured materials containing multiple components.

Various methods may be used to apply dispersed carbon nanotube-superacid solutions onto a surface. In some embodiments, the applying step may include at least one of filtration, printing, casting, coating, dip coating, die coating, rod coating, spray coating, slot coating, gravure coating, slide coating, knife coating, air knife coating, curtain coating, screen coating, and combinations thereof. In some embodiments, the applying step comprises dip coating. In some embodiments, the carbon nanotube films fabricated using dip coating may have the carbon nanotubes aligned in the dip coating direction.

Various methods may also be used to remove superacids from formed carbon nanotube films. Such methods may include, without limitation, direct coagulation, addition of polymers, evaporation, filtration through a screen, and combinations thereof. In some embodiments, the removing step is by direct coagulation, and the step comprises dipping the carbon nanotube film in pure solvents or mixtures of solvents. In some embodiments, the solvent comprises chloroform, ether, isopropanol, acetone, ethanol, methanol, and combinations thereof.

In some embodiments, the removing step may involve evaporation. In more specific embodiments, the evaporation may occur by various methods known in the art. Such methods may include, without limitation, vacuum drying, freeze drying, microwave drying and combinations thereof. In some embodiments, the evaporation occurs by vacuum drying. In various embodiments, the removing step may include, without limitation, heating by oven drying, exposure to hot gas, microwaving, or combinations thereof.

In some embodiments, the methods of the present disclosure may also include a step of separating the formed carbon nanotube film from a surface to produce a freestanding carbon nanotube film. In some embodiments, such separation occurs by floating in water. In other embodiments, the separation occurs by contact with another surface. In yet other embodiments, the separation occurs by wetting with another liquid that does not dissolve the carbon nanotubes.

In some embodiments, the carbon nanotube films formed by the methods of the present disclosure may be naturally acid-doped. Acid-doping may be controlled by known methods. For instance, in some embodiments, the removal step may be followed by washes in diethyl ether and then water, or a wash in diethyl ether alone to get the desired level of acid-doping. In some embodiments, the doping can be performed with other molecules, such as Iodine.

Carbon Nanotube Films

The methods of the present disclosure may be utilized to make various types of carbon nanotube films. As set forth previously, carbon nanotube films of the present disclosure may include a plurality of carbon nanotubes that are dispersed and individualized. In some embodiments, the carbon nanotube films may be freestanding. In some embodiments, the carbon nanotube films may be immobilized onto a surface.

The carbon nanotubes on the carbon nanotube films of the present disclosure may have various thicknesses. In some embodiments, the carbon nanotubes on the films may have a thickness that ranges from about 1 nm to about 1 μm. In some embodiments, the carbon nanotubes on the films may have a thickness that ranges from about 10 nm to about 100 nm. In some embodiments, the carbon nanotubes on the films may have a thickness that ranges from about 10 nm to about 20 nm.

The carbon nanotubes on the carbon nanotube films of the present disclosure may also have various arrangements. In some embodiments, the carbon nanotube films may include individualized carbon nanotubes. In some embodiments, the individualized carbon nanotubes may be isotropically oriented. In some embodiments, the carbon nanotube films may include aligned carbon nanotubes. In some embodiments, the carbon nanotube films of the present disclosure may include bundles of aligned carbon nanotubes. In some embodiments, the carbon nanotube films comprise isotropically oriented bundles of aligned carbon nanotubes. In some embodiments, the carbon nanotube films may comprise mixtures of isotropically oriented carbon nanotubes and bundles of aligned carbon nanotubes. In more specific embodiments, the liquid crystals of aligned carbon nanotubes may have an ellipsoidal shape or a thread-like appearance. In some embodiments, the carbon nanotube films of the present disclosure may include mixtures of isotropically oriented carbon nanotubes and bundles of aligned carbon nanotubes. In some embodiments where the applying step is by flow coating (e.g., dip coating, slot coating, roll coating, etc.), the bundles of the carbon nanotubes are aligned in the coating direction.

In some embodiments, the carbon nanotube films may include long carbon nanotubes. In more specific embodiments, the long carbon nanotubes may have lengths that range from about 1 inn to about 100 μm, or from about 5 μm to about 20 μm.

The carbon nanotube films of the present disclosure may have various advantageous properties. For instance, in some embodiments, the carbon nanotube films of the present disclosure may have an average transmittance of about 60% to about 100% at 550 nm. In some embodiments, the carbon nanotube films may have an average transmittance of about 10% to about 70%. In some embodiments, the carbon nanotube films may have an average transmittance of about 1% to about 40%. In some embodiments, the carbon nanotube films may have an average transmittance below about 10%.

In some embodiments, the carbon nanotube films of the present disclosure may have an average sheet resistance of about 20 ohm/sq to about 4,000 ohm/sq, from about 20 ohm/sq to about 1530 ohm/sq, from about 20 ohm/sq to about 200 ohm/sq, or from about 0.1 ohm/sq to about 50 ohm/sq. In some embodiments, the carbon nanotube films of the present disclosure may have conductivities that range from about 1.1×10⁵ S/m to about 3.1×10⁵ S/m, from about 2.5×10⁵ S/m to about 5.5×10⁶ S/m, from about 0.25×10⁵ S/m to about 1.5×10⁵ S/m, from about 2.75×10⁵ S/m to about 8.5×10⁵ S/m, or from about 7.3×10⁵ S/m to about 5.5×10⁶ S/m.

In sum, the carbon nanotube films made by the methods of the present disclosure can be thin, conductive, and highly transparent. As such, the methods of the present disclosure may be used to make carbon nanotube films for various applications. For instance, in some embodiments, the transparent, conductive, and thin films that are made by the methods of the present disclosure may exceed those of state-of-the-art indium tin oxide (ITO) films, while offering competitive advantages such as flexibility, durability, resistance to fatigue, and availability. Thus, in some embodiments, the films made by the methods of the present disclosure may be used for making touch screen panels and liquid crystal displays. In some embodiment, the films made by the methods of the present disclosure may be used in solar cells, flexible electronics, organic light-emitting diodes, electromagnetic interference shielding, as well as various antistatic, optical, and sensor coatings.

### Additional Embodiments

From the above disclosure, a person of ordinary skill in the art will recognize that the methods and systems of the present disclosure can have numerous additional embodiments. Reference will now be made to more specific embodiments of the present disclosure and experimental results that provide support for such embodiments. However, Applicants note that the disclosure below is for exemplary purposes only and is not intended to limit the scope of the claimed invention in any way.

### EXAMPLES

Additional details about the experimental aspects of the above-described studies are discussed in the subsections below.

### Example 1

### Materials and SWNT Solution Preparation

Carbon nanotubes used in the Examples herein are single-walled carbon nanotubes (SWNTs) produced using the high pressure carbon monoxide (HiPco) method (Rice University; batch #188.2). The HiPco SWNTs have an average length of 500 nm and a diameter of 1 nm. The amorphous carbon and iron catalyst were removed by oxidizing at a temperature of 375 C in the presence of SF₆ and O₂, followed by washing with 6M HCl at 90 C. Dip coating solutions were prepared by stir-bar mixing for 24 hrs. Volume fraction was calculated by assuming a density of 1300 kg/m₃ for the SWNTs.

### Example 2

### Film Formation Process

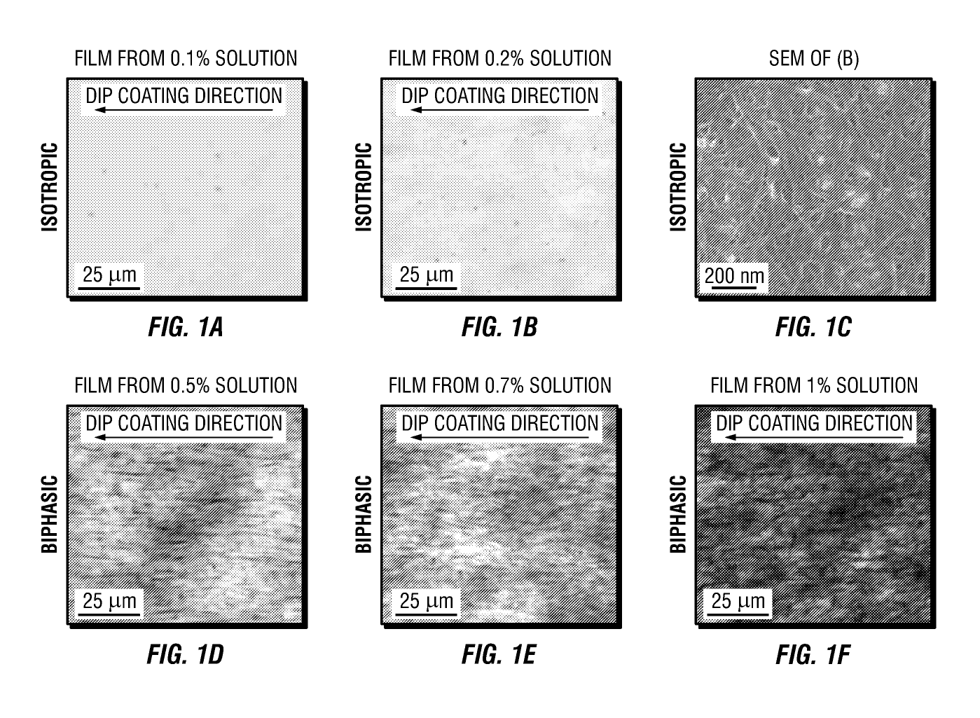

The actual dip coating setup consists of a vertically mounted syringe pump (Harvard Apparatus PHD 2000) as shown in the schematic diagram (FIG. 1B). Different withdrawal speeds were obtained by controlling the volumetric flow rates for an arbitrarily assigned syringe diameter. The dip-coated film contains both SWNT and the solvent (i.e. chlorosulfonic acid). As soon as the liquid film was withdrawn from the dip coating solution, it was immersed in chloroform for at least 15 mins to remove the acid. It should be noted that upon moisture exposure, chlorosulfonic acid decomposes into hydrochloric gas and sulfuric acid, causing significant de wetting of the film, due to high surface tension of sulfuric acid. To avoid moisture contamination, the whole operation was carried out inside a glove bag constantly purged with anhydrous argon gas, as shown in FIG. 1B.

### Example 3

### Characterizations

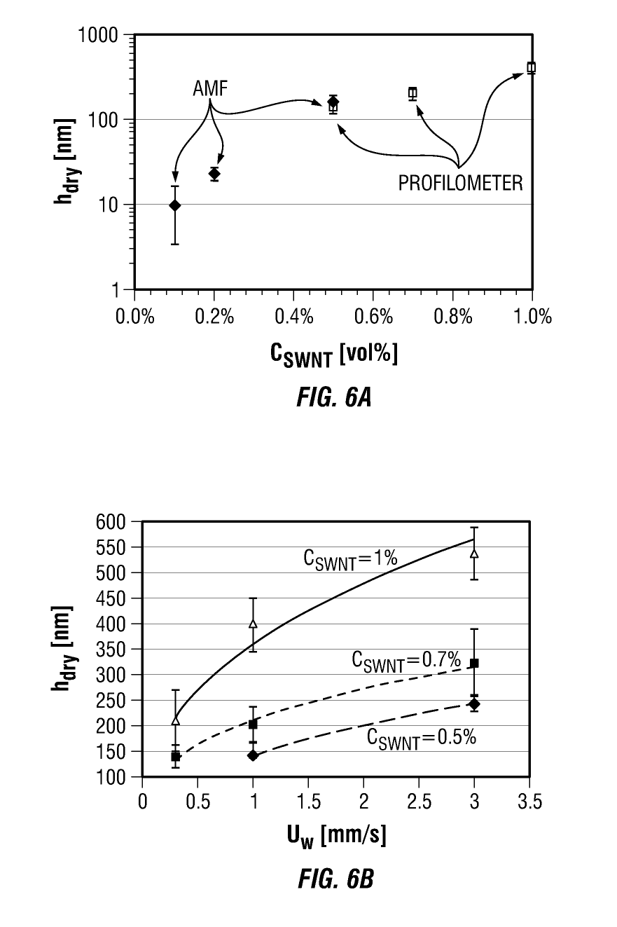

Light microscopy images of the dip coating solutions and final SWNTs films were captured using a Zeiss Axioplan optical microscope. Liquid samples were prepared inside an anhydrous glove box as described, where the sample solution was confined between a microscope slide and cover slip, and sealed with aluminum tape. SEM images were captured using JEOL 6500F. For TEM samples, the SWNT film was detached from the glass substrate by submerging the sample into DI water. A TEM grid was then used to recover the detached part of the film for imaging (JEOL 2010, 100 kV). Steady shear rheology of the solutions was characterized using a stress-controlled rheometer (AR 2000ex; TA Instruments) enclosed inside a custom-made glove box constantly purged with dry air. Relative humidity during sample loading and testing was kept below 2-3%. Parallel plate geometry made of stainless steel (SS 316) was used. SWNT film thickness (after chloroform quenching) was measured using mechanical profilometer (Vecco Dektak 6M) and atomic force microscopy (AFM; Digital Instruments Nanoscope IIIA). For profilometer measurements, the error bar of each data point in FIG. 6 represents the standard deviation of nine measurements (three films were dip coated from the same solution and three measurements were performed at various locations on each film). For AFM measurements, the error bar represents three measurements carried out at different locations of the same film. Films produced from the 0.5% solution were measured using both AFM and profilometer, and the measurements agree to within 10%. Sheet resistance was measured using the 4-point probe method (Jandel), and transmittance at 550 nm was measured by UV-Vis spectrometer (Shimadzu UV-1800).

### Example 4

### CNT Solution Preparation and Set-Up

Purified DWNTs were purchased from CCNI (batch X647H). HiPco SWNTs (batch 188.3) were produced at Rice University and purified according to literature methods. The average length of DWNTs was estimated to be about 10 μm and they were mostly few-walled nanotubes (single, double and triple walls with an average wall number of 2.25, and an external diameter of about 2.4 nm). CSA was used as received (grade 99%, purchased from Sigma-Aldrich). The CNTs and CSA were initially mixed at ˜10000 ppm in a speedmixer (DAC 150.1 FV-K, Flack Tek inc). This stock solution was then diluted to the coating concentrations by further speedmixing for 10 to 20 minutes, followed by stir-bar mixing for 24 hours. Each film was coated on a glass slide previously cleaned with acetone (C₃H₆O) and then air dried. A motorized stage (vertically-mounted syringe pump, Harvard Apparatus PHD 2000) was used to immerse and lift the glass slide into and out of both the CNT-CSA solution and chloroform bath at prescribed speed. In the case of simple chloroform coagulation (method (1)), the films was immersed in chloroform for at least 20 minutes to ensure complete removal of the CSA. Finally, the film was annealed at 115° C. for 30 minutes to improve their adhesion to the glass support. When the complete sulfuric acid removal was desired (method (2)), the glass slide was first immersed in chloroform for 20 minutes after fabrication. Then, the glass slide was left in a diethyl ether bath for 3 minutes. After the ether washing, the film was annealed in the oven at 115° C. for 15 minutes to improve the adhesion to the glass slide. Finally, the glass slide was immersed in a water bath to remove the residual sulfuric acid. The process was completed with another 15 minutes in the oven at 115° C. to dry the film. The intermediate film annealing between diethyl ether and water wash is necessary to avoid the detachment of the film from the substrate. The CSA removal was also performed using direct CSA evaporation (method (3)) as described elsewhere. Saha, A.; Ghosh, S.; Weisman, R. B.; Martï, A. A., Films of Bare Single-Walled Carbon Nanotubes from Superacids with Tailored Electronic and Photoluminescence Properties. ACS Nano 2012, 6(6) 5727-5734. In brief, the film was heated in a vacuum oven at 150° C. after fabrication for 20 minutes. Then, the glass slide was immersed in a diethyl ether bath for 3 minutes and dried in oven for another 10 minutes. The whole dip-coating and coagulation process was performed in a glove box purged continuously with dry air in order to keep the moisture concentration less than 10%. The presence of water vapor could result in an exothermic reaction between the residual moisture and chlorosulfonic acid that may affect the integrity of the films due to the generation of HCl gas. The film deposited on one side of the glass slide was wiped off before the transmittance measurements.

### Example 5

### Characterization

The CNT film morphology was studied using a Zeiss Axioplan optical microscope. TEM images were captured using JEOL 2010. The TEM sample preparation was achieved by immersing the dip-coated slides into a DI water bath after chloroform coagulation and transferring of the floating films onto a TEM grid. Films produced in this manner can be easily detached from the glass slide and transferred to other substrates. FEI quanta 400ESEM FEG was used to obtain the SEM pictures. The transmittance of the films at the wavelength of 550 nm was measured by a UV-Vis spectrometer (Shimadzu UV-1800), while the sheet resistance was obtained with a linear four-point probe device (Jandel model RM3-AR). The XPS spectra and the rheology data were obtained using PHI Quantera XPS and AR2000eX (TA Instruments) with a concentric cylinder Couette geometry, respectively.

### Example 6

### Formation of Randomly Oriented SWNT Films from Isotropic Solutions

Single-walled CNT (SWNT) films were formed in a three-step process: formation of a superacid solution; coating the solution on a glass substrate; consolidation of structure by solvent removal. First, SWNTs were individually dispersed in chlorosulfonic acid at low concentrations (0.1% and 0.2%), forming single-phase isotropic solutions. These solutions were then coated onto a glass substrate by dip coating. Because of the low volatility of chlorosulfonic acid, the acid was subsequently removed from the wet film by immersion in chloroform. This solvent extraction step resembles the coagulation step in wet spinning of neat CNT fibers and differs from conventional dip coating, where the (volatile) solvent is evaporated away. The resulting solid films have a thickness of tens of nm (FIGS. 1A and 1B; Table 1), show no optical birefringence, and consist of randomly oriented SWNTs (FIG. 1c). They have an average transmittance of 67% and 90% (at 550 nm), and an average sheet resistance of 135 and 1530 Ω/sq respectively (Table 1), potentially useful as flexible, transparent, and conductive coatings for touch screen applications.

TABLE 1
Sheet resistance and final film thickness of SWNT films prepared from
different concentrations of SWNT-superacid solutions (C_{SWNT}).
Each sheet resistance value was calculated based on measuring three
different locations of three films dip coated from the same concentration
solution. Film thickness for the 0.1% and 0.2% films was measured by
AFM, whereas that for the 0.5%, 0.7%, and 1% films was
measured by a mechanical profilometer.

| | | h_{dry} |
|---|---|---|
| C_{SWNT} | R [Ω/sq] | [nm] |
| 0.1%* | 1531 ± 313 | 10 ± 6 |
| 0.2%* | 135 ± 36 | 23 ± 4 |
| 0.5% | 62 ± 35 | 143 ± 16 |
| 0.7% | 22 ± 1 | 201 ± 35 |
| 1% | 8 ± 3 | 397 ± 51 |

*Note:
SWNT whiskers were NOT observed in films dip coated from the isotropic solutions (0.1% and 0.2%).

### Example 7

### Formation of Whisker-Like SWNT Crystallites from Biphasic Solutions

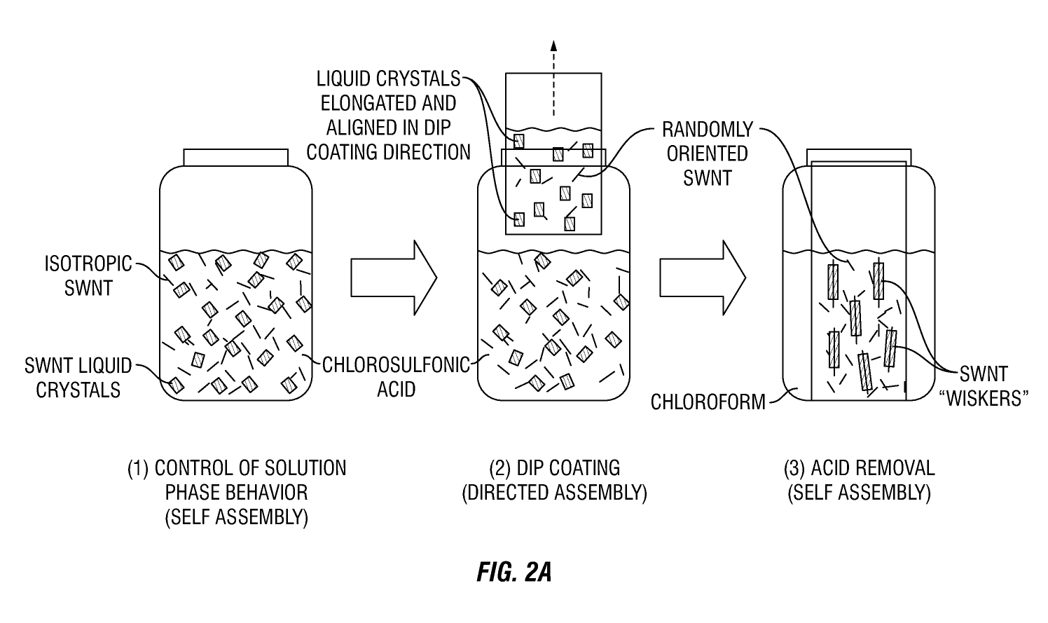

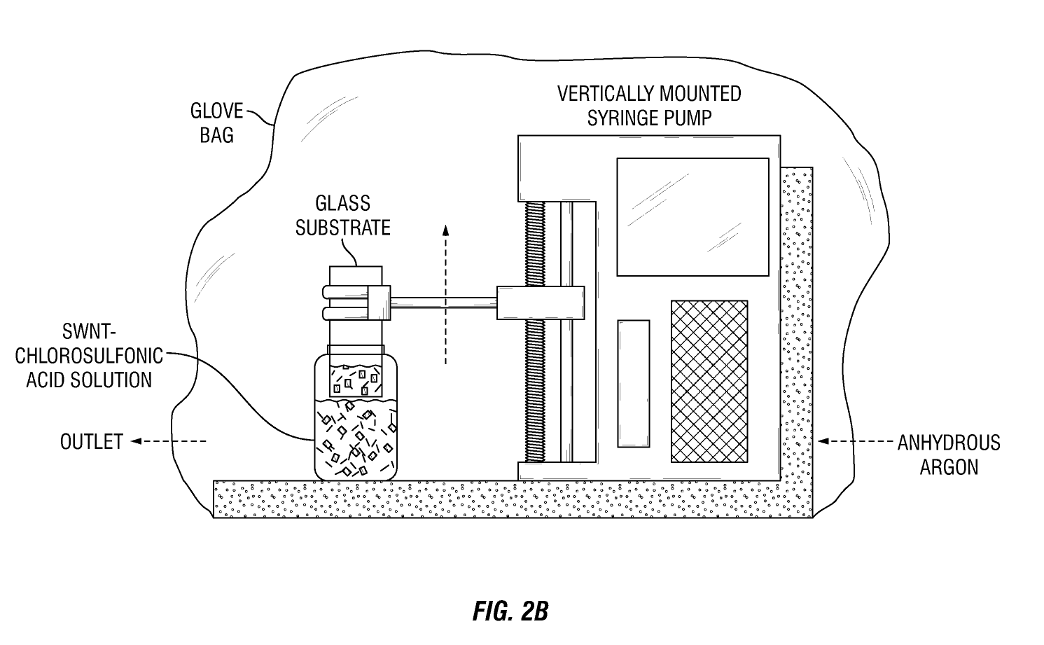

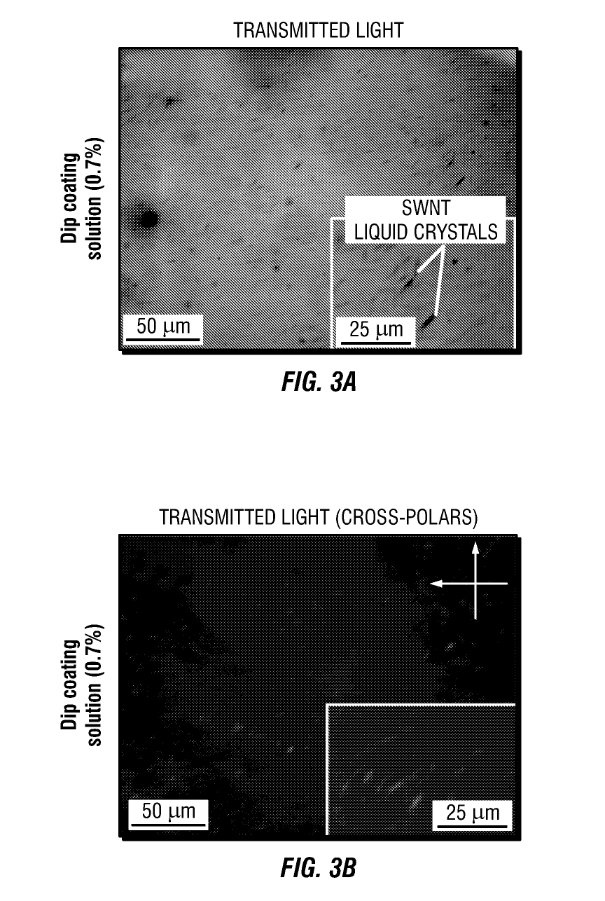

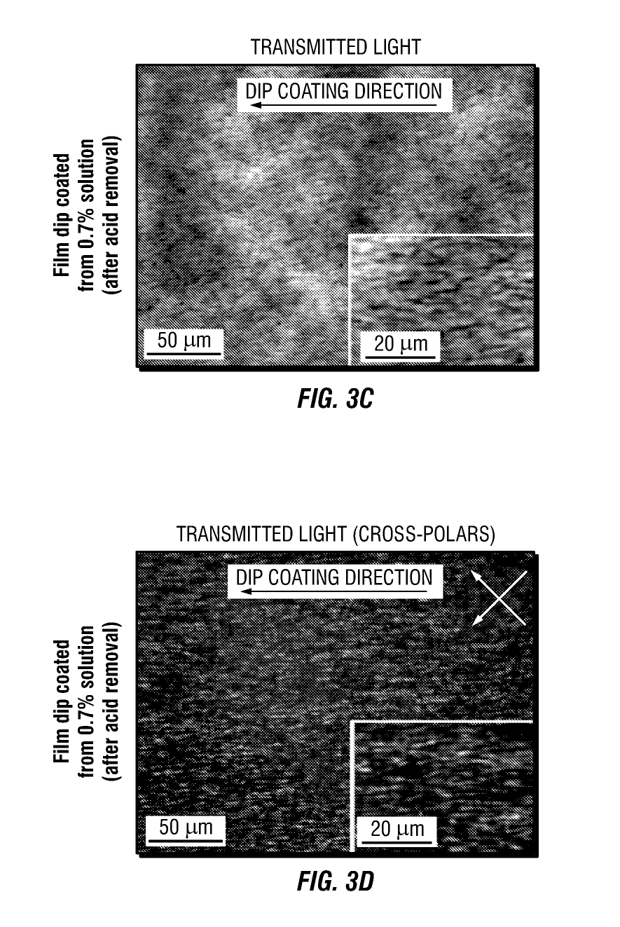

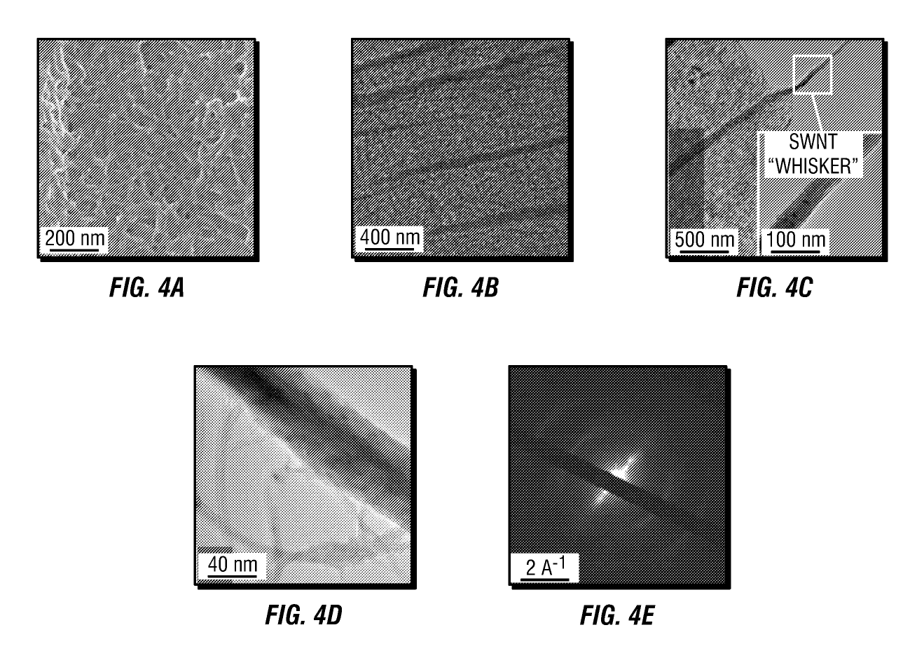

To attain films containing highly aligned, whisker-like SWNT crystallites, dubbed hereafter ‘SWNT whiskers’, a higher concentration solution was used (FIG. 2). As the CNT concentration grows, excluded volume interactions cause the formation of liquid crystalline (LC) domains consisting of aligned CNTs; the solution transitions from an isotropic phase of randomly oriented CNTs to a biphasic system, where a liquid crystalline phase co-exists with an isotopic phase. In this regime, concentration and acid strength control the morphology of the LC domains, which can vary from nearly endless threads (spaghetti) to ellipsoidal (acicular) as the solvent goes from sulfuric to chlorosulfonic acid. At even higher concentrations, CNT in acids form a LC with polydomain morphology. FIG. 3 shows the optical microstructure of a biphasic solution—0.7% (vol.) SWNT in chlorosulfonic acid—captured using transmitted light, with (FIG. 3B) and without (FIG. 3A) cross-polarizers. As shown in the polarized light micrograph (FIG. 3B), several discrete LC structures in the solution show optical birefringence (“lit up”), indicating intrinsic alignment of SWNT within these structures. These LC structures have a peculiar ellipsoidal (acicular) shape, likely due to the strong elastic energy (splay and bend) and low interfacial tension in the system. Similar acicular shape LC structures were recently reported for aqueous dispersions of bile-salt stabilized SWNTs, but the director within these structures were found to be uniform rather than bipolar. Unlike the convective assembly method reported for aqueous CNT solutions where the gradual evaporation needed to concentrate the solution and form a liquid crystal occurs over several days, the acid removal process generally takes minutes or less to complete and therefore has a much shorter processing time.

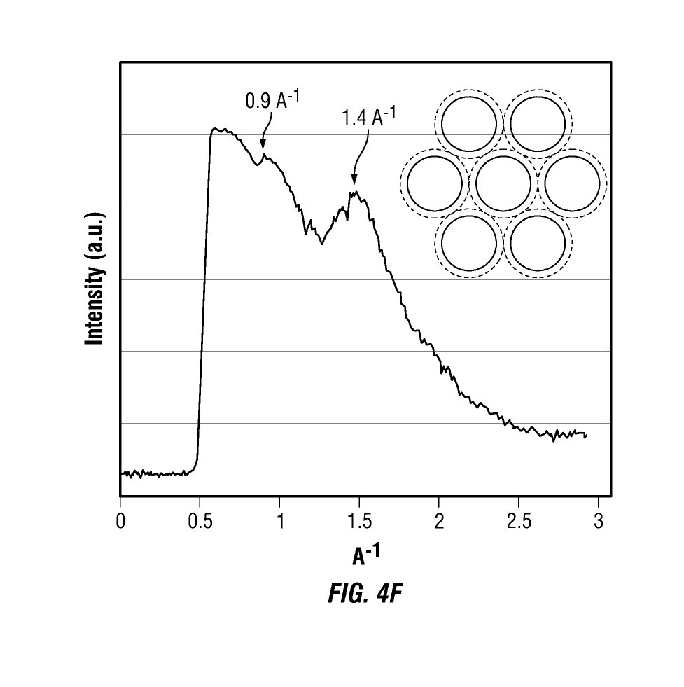

FIGS. 3C and 3D show representative light micrographs of the resulting film captured using transmitted light (with and without cross-polarizers). As shown in the figures, the resulting film contains structures that are preferentially aligned along the dip coating direction. No preferential alignment of LC domains is observed in the biphasic solutions. Therefore, the streamwise alignment must be caused by the dip coating process. Because the LC domains are fluid, they may undergo stretching in addition to alignment in the high shear film formation zone. These elongated LC domains then act as nucleating sites for the further growth of large, SWNT whiskers during subsequent acid removal process (FIG. 2). SWNT whiskers are typically 10 to 20 μm long and ˜100 nm thick. They are strongly birefringent in polarized light microscopy (FIG. 3D), indicating that the SWNTs within these structures are highly aligned. It is worth noting that in the case of thermotropic liquid crystalline polymers, macroscopic alignment of polymer crystallites can be obtained by applying shear to the specimen during annealing. In the present disclosure, the inventors show that by using the right solvent and processing flow conditions, SWNTs can be processed in an analogous way to obtain crystallite structures with macroscopic alignment. Transmission and scanning electron microscopy (TEM and SEM) were performed on the dried films. Interestingly, SWNT whiskers are only visible in transmission mode (TEM) (FIGS. 4B& 4C) but not in surface scanning mode (SEM) (FIG. 4A), indicating that these structures are embedded within a random network of SWNT. This is similar to the case of crystallites found in polymer melt systems, where crystallites cannot be captured by SEM unless the amorphous portion of the specimen is etched selectively. TEM shows that SWNT whiskers typically have a maximum width of 100 nm. Their alignment may not be fully resolved because they are embedded in a random SWNT network. Nevertheless, as part of the film was broken and transferred from the glass substrate onto a TEM grid, some SWNT whiskers protruded out of the random network at the edge of the specimen (FIG. 4C). Clear alignment of SWNT within the whisker is shown in FIG. 4D. FIG. 4E shows the corresponding electron diffraction pattern containing information about SWNTs packing within the whisker. Henrard et al. showed in their electron diffraction simulations and experiments that clear peaks along the central line are present in SWNT bundles, due to the tubes being packed in a triangular lattice. The exact position and breadth of these peaks are influenced by average diameter, diameter distribution and overall alignment. Two peaks were observed at 0.9 Å₋₁ and 1.4 Å₋₁ along the central line of the electron diffraction of the SWNT whisker (FIG. 4F), in qualitative accord with the published patterns. This indicates that SWNTs are aligned as well as packed in a crystalline manner (inset of FIG. 4F), and may be of larger diameter than 16.8 Å analyzed by Henrard et al. The first and second layer lines are neither uniformly intense, nor clearly spotty. Such feature is typical of bundles with mixed chirality indicating that SWNT whiskers are made of SWNTs with mixed chirality.

### Example 8

### Macroscopic Alignment of SWNT Whiskers

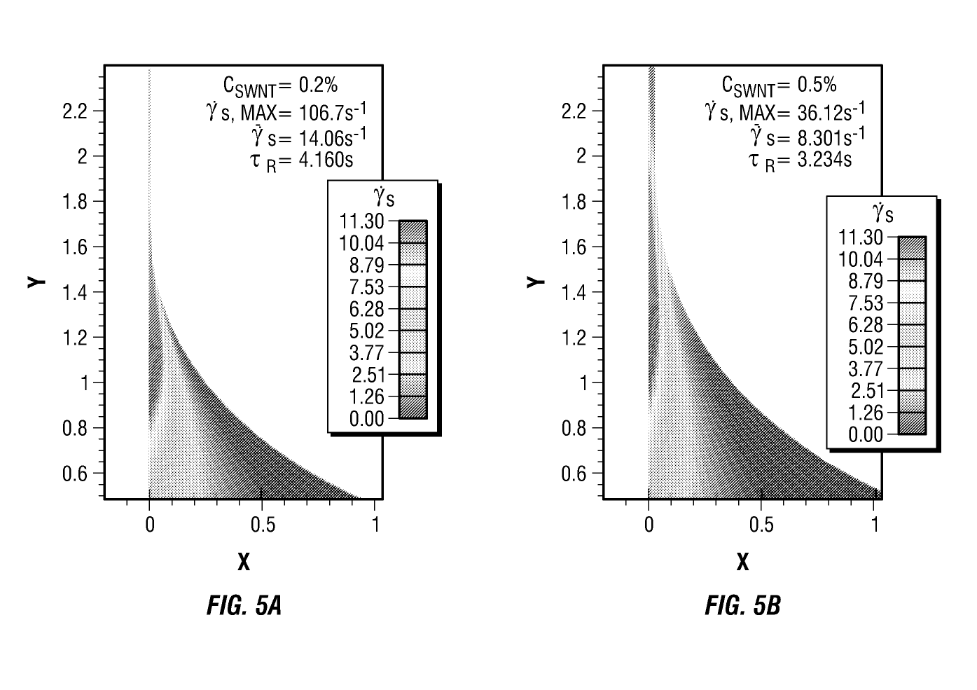

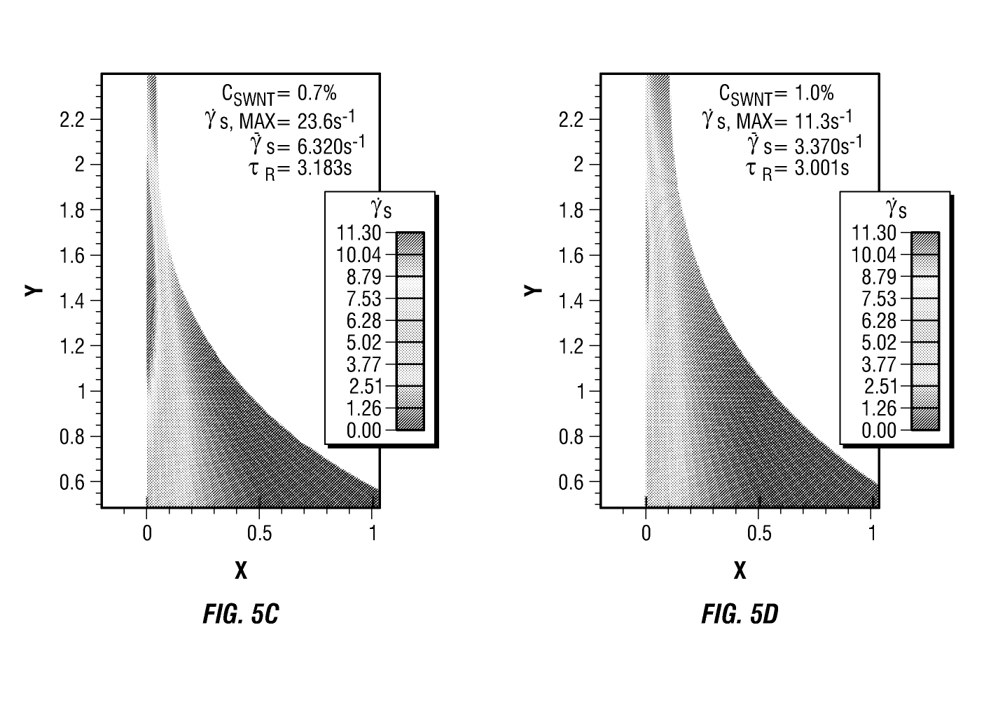

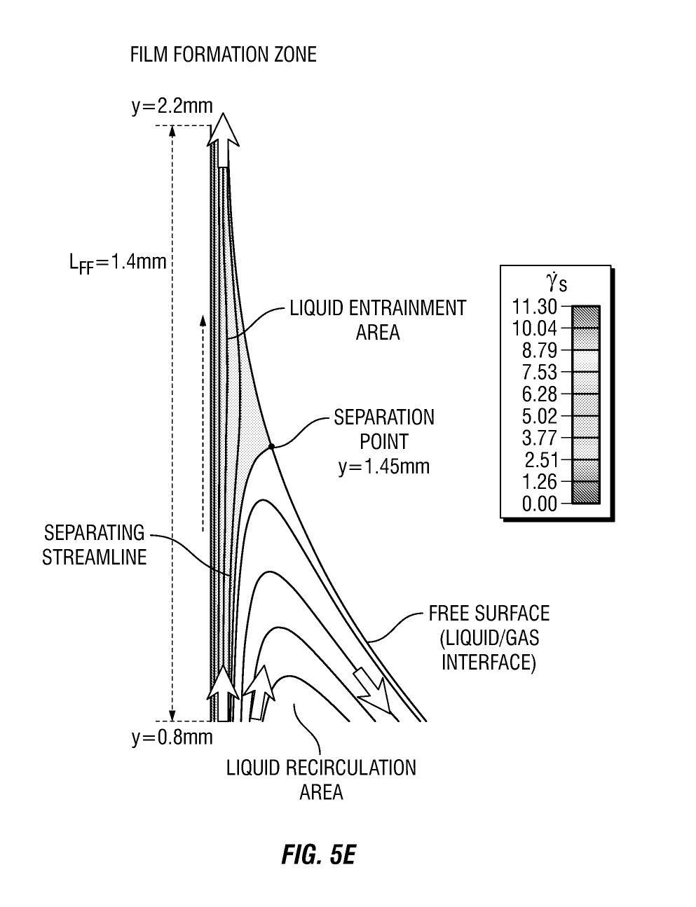

To understand why SWNT whiskers are aligned but individual SWNTs are not, two dimensional steady state flow equations were solved numerically by using a previously published Galerkin-finite element methods. The input parameters for the modeling were obtained by fitting the rheological data to a power-law fluid model. The surface tension of the chlorosulfonic acid solutions was measured to be 22.31 mN/m using the pendant drop method (KSV CAM 200 Contact Angle Tool). FIGS. 5A-5D show the shear rate profile generated during the dip coating process for different concentrations of SWNT solutions. In the dip coating process, the highest local shear rate [symbol] occurs close to the moving substrate and decreases to zero as the free surface is approached. The average shear rate is defined as:

$${\overline{\dot{γ}}}_{s} = \frac{{\int }_{{A}_{e}} {\dot{γ}}_{s} d A}{{\int }_{{A}_{e}} d A} = \frac{{\int }_{{A}_{e}} {\dot{γ}}_{s} d A}{{A}_{e}}$$

where Aₑ is the liquid entrainment area, and it contains elements with a stream function value higher than that at the separating streamline (see FIG. 5E). For SWNTs and LC structures to align, the Peclet number should be large, i.e.,

$$Pe = ≫ 1 , {D}_{r} ≫ 1 ,$$

where Dᵣ is the rotary diffusivity. The rotary diffusivity of individual SWNTs for the semi-dilute, isotropic 0.1% and 0.2% solutions is estimated to be 0.8 s₋₁ and 0.2 s₋₁, respectively, whereas that for LC structures is estimated to be ˜0.001 s^{-1 54}. The highest local shear rate [symbol] generated from dip coating biphasic solutions ranges from 11-36 s⁻¹. Therefore, the Pe number for LC structures is of the order of 10,000 (indicating strong flow alignment) while it is several orders of magnitude smaller (˜10 to 50) for individual SWNTs (indicating weak alignment). Moreover, the rotational relaxation time

$${τ}_{r} = \frac{1}{6 {D}_{r}}$$

of the whiskers is in the range of tens of minutes, indicating that the whiskers cannot reorient before solvent extraction, whereas the SWNT can rearrange in less than one second and would therefore lose any flow alignment as the liquid film is transferred into chloroform. Discrete LC structures deform when the hydrodynamic forces are strong enough to overcome the elastic and interfacial ones. The capillary number Ca for a LC structure suspended within an “isotropic SWNT” medium is estimated to be ˜4, i.e., the flow-induced shear stresses on the interface LC tactoids exceed the interfacial tension. Similarly, the Ericksen number Er is estimated to be on the order of 10, i.e. the shear stresses are sufficiently high to overcome the elastic stresses due to deformation of the domains. This simple scaling analysis suggests that the discrete LC structures are stretched in the high shear flow during film formation.
The orientation distribution of whiskers and the angle of misalignment from the dip coating direction were calculated using ImageJ with plugin “OrientationJ”. As shown in Table 2, whiskers in 1% film have a larger angle of misalignment (±14.1°) from the dip coating direction compared with those in the 0.5% and 0.7% films (±10.4°). This can be explained by considering the shear rate and strain experienced by LC structures. As the solution concentration increases, both the maximum [symbol] and average shear rate {dot over ( γ̅ₛ decrease. The residence time t_{R} is:

$${t}_{R} = \frac{{\int }_{{A}_{e}} d A}{q} = \frac{{A}_{e}}{q} ,$$

where q is the flow rate (2-D) through the outflow boundary. Because the flow rate q grows faster than the liquid entrainment area Aₑ, both the residence time t_{R} and the total strain (= [symbol] ·t_{R}) experienced by the SWNT decrease. The lower alignment in the 1% film can therefore be explained by: (1) lower average shear rate and (2) smaller strain experienced by the LC structures during the dip coating process.
Table 2-Degree of whisker misalignment (\sqrt{ [symbol]θ² [symbol]}) for films dip coated from different concentrations of SWNT-acid solutions (0.1%, 0.2%, 0.5%, 0.7%, and 1%), where θ is the angle between the whisker axis and the dip coating direction. The orientation distribution of whiskers was calculated from the optical micrographs using ImageJ plugin OrientationJ, and each reported \sqrt{ [symbol]θ² [symbol]} value was averaged over 3 arbitrarily chosen areas (300 μm×300 μm).

EXAMPLE 9

| Films dip | | |
|---|---|---|
| coated from | | \sqrt{ [symbol] θ² [symbol] } |
| Isotropic | 0.1% | No whisker formation |
| solutions | 0.2% | No whisker formation |
| Biphasic | 0.5% | ±10.4° |
| solutions | 0.7% | ±10.4° |
| | 1% | ±14.1° |

### Film Thickness and Sheet Resistance

Film thickness depends on SWNT concentration and substrate withdrawal speed. For a fixed substrate withdrawal speed, lower concentration solutions produce thinner films because they have lower viscosities and contain fewer SWNTs, as shown in FIG. 6A and Table 1. FIG. 6B shows film thickness (after acid removal) as a function of substrate withdrawal speed. Gutfinger and Tallmadge applied lubrication analysis to power-law fluids (ηₐ=K [symbol] ⁻¹) and showed that the film thickness should scale as:

$${h}_{dry} ∝ {h}_{wet} ∝ {U}_{o}^{\frac{2 n}{2 n + 1}} ,$$

where Uₒ is the substrate withdrawal speed. Table 3 compares the predicted scaling exponents (using n values from rheological measurements) with those determined from FIG. 6B. The values for 0.5% and 0.1% solutions agree to within ˜2% and those for the 0.7% solution agree to within ˜20%. The sheet resistance of the SWNT films is reported in Table 1. Films dip coated from higher concentration of SWNT are thicker and have lower sheet resistance. Based on the sheet resistance and thickness data, the conductivity for the 0.5%, 0.7% and 1% films containing SWNT whiskers varies from 1.1×10⁵ S/m to 3.1×10⁵ S/m, which is comparable to values reported for SWNT films produced from filtration (using HiPco nanotubes) and acid doped SWNT fibers₁₁ (5×10 S/m). Although most of the acid has been removed during the coagulation step, the films are naturally doped with trace amounts of adsorbed acid, which increases their conductivity. Acid doping can be removed by heat treatment, yielding ˜three-fold higher sheet resistance after heating at 150° C. for 24 hours.

TABLE 3
Scaling exponent (α) for film thickness (h) as a function of substrate
withdrawal speed (Uₒ) (i.e. h_{dry} ∝ Uₒ ^{α}). Comparison between α obtained
from lubrication analysis ⁵⁸ and from FIG. 6b.

| | | α predicted in | |
|---|---|---|---|
| | n value from | lubrication analysis (i.e. | α from |
| C_{SWNT} | rheology | 2n/(2n + 1)) | FIG. 6b |
| 0.5% | 0.47 | 0.49 | 0.48 |
| 0.7% | 0.45 | 0.48 | 0.37 |
| 1.0% | 0.36 | 0.42 | 0.41 |

### Example 10

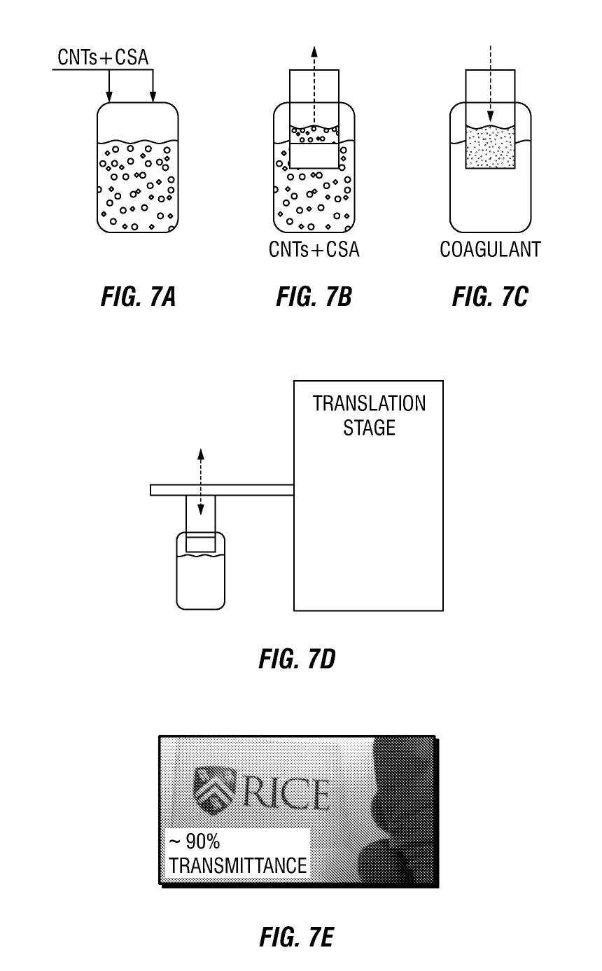

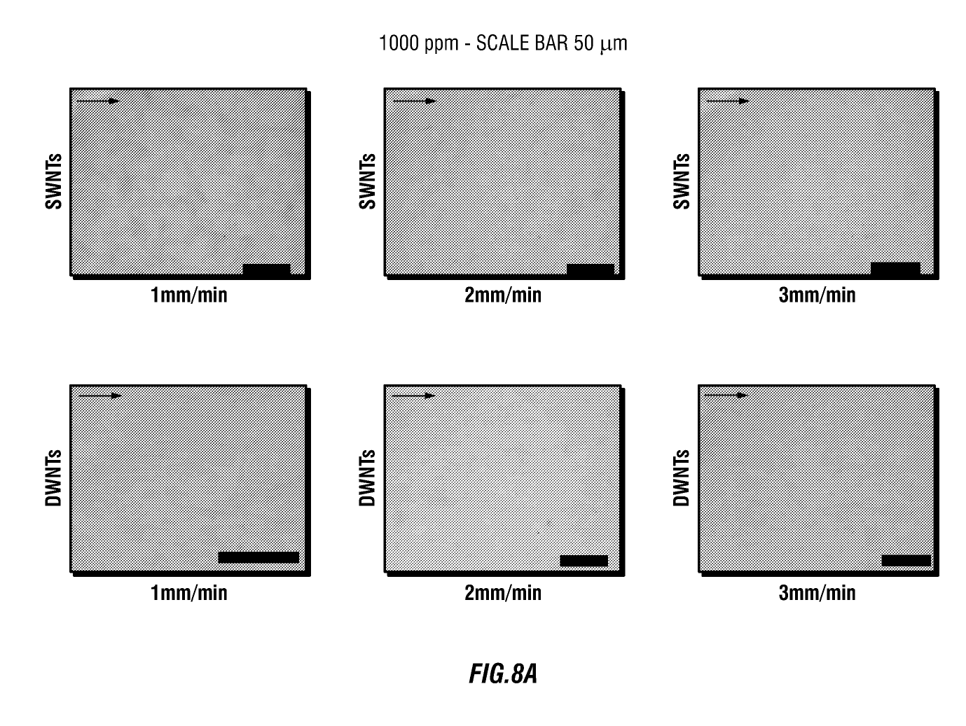

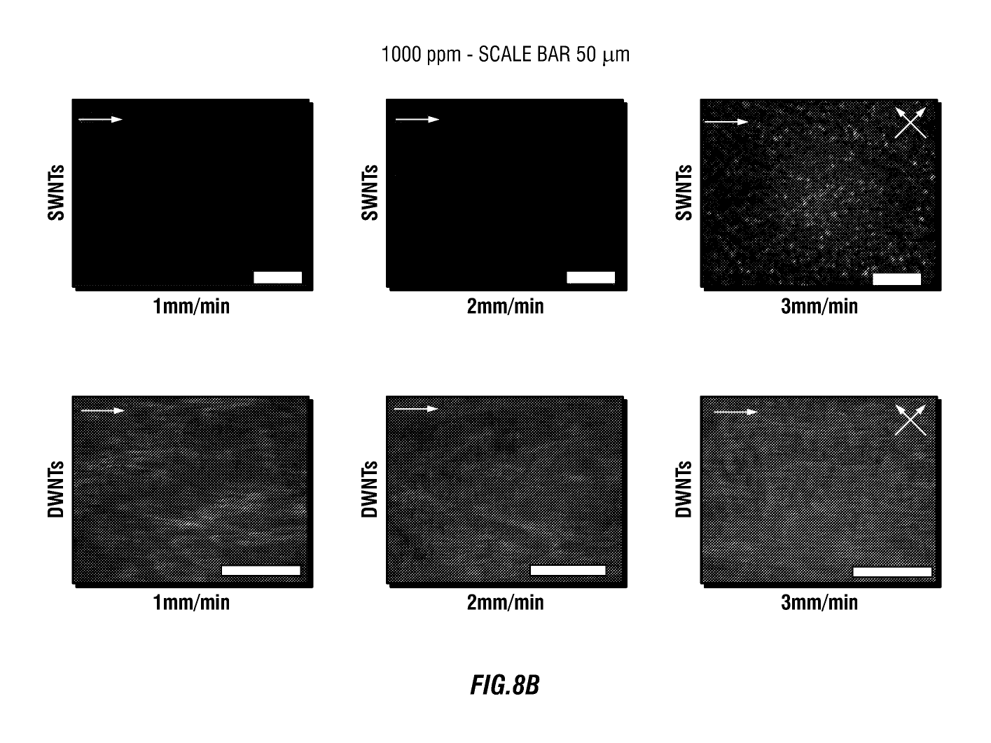

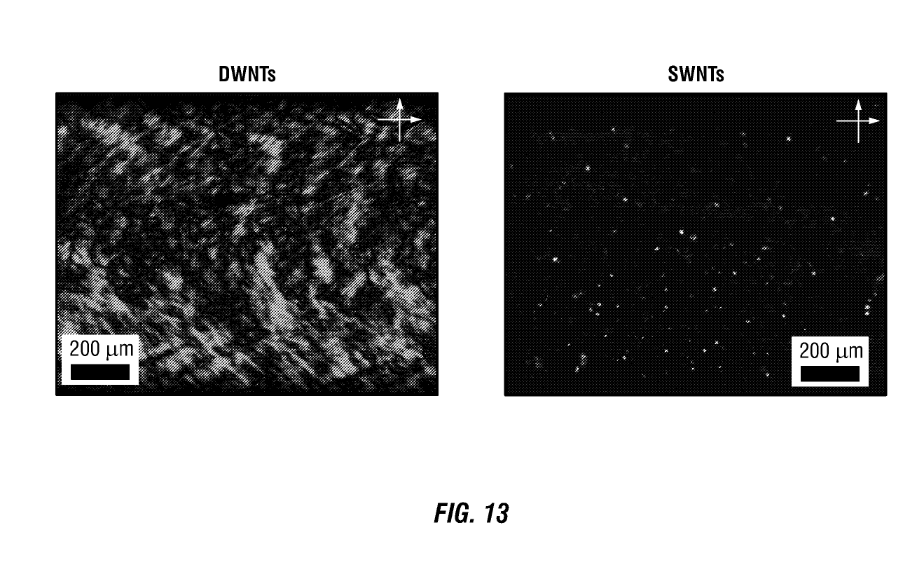

Thin films were fabricated starting from solutions of CNTs in CSA. Both HiPco SWNTs (length L˜0.0.5 μm, diameter D˜1 nm) and DWNTs (L˜10 μm, D˜2.4 nm) were used. SWNTs and DWNTs were dissolved (without sonication) in CSA at 1000, 2000, and 3000 ppm wt % (deposition from lower concentration solutions yielded sparse CNT coverage, high transparency ˜99.5%, and high sheet resistance Rₛ˜12 kΩ/sq). Beyond a critical concentration w₁, CNTs form biphasic solutions with an isotropic (randomly oriented) phase in equilibrium with a nematic liquid crystalline phase. This optimal concentration scales inversely with CNT aspect ratio as w₁˜D/L. The measured transition concentrations were 4100 ppm for SWNTs and 125 ppm for DWNTs. Therefore, the SWNT solutions were isotropic, whereas the DWNT solutions contained a small amount of nematic phase (˜10 to 20% depending on overall concentration—see FIG. 13 for images of SWNT and DWNT solutions). Glass slides were lowered into the CNT-CSA solution and were withdrawn at a controlled speed by a motorized arm (see FIG. 7). Three methods were used to remove CSA from the films: (1) coagulation by immersion of the glass slide in chloroform (CHCl₃) followed by oven drying; (2) coagulation by immersion of the glass slide in chloroform, followed by washes in diethyl ether (C₄H₁₀O) and then water, with final oven drying; (3) direct evaporation of CSA in a vacuum oven at 150° C. followed by diethyl ether wash and drying as shown in previous literature. FIG. 7E shows an example of a 90% transmittance film fabricated using the dip coating technique. All three methods yielded homogeneous films (FIG. 8A) but different amounts of residual sulfuric acid (H₂SO₄) doping (see discussion below). Chloroform was chosen as the coagulant because it dissolves CSA without reacting (unlike water that forms hydrochloric acid (HCl) gas and sulfuric acid), which can damage the film structure. Because of its high volatility, chloroform rapidly evaporates from the film once the slide is removed from the bath. However, chloroform is not a good solvent for sulfuric acid and hence leaves residual acid in the film. Thus, washing in diethyl ether and water may be desired to remove sulfuric acid whenever sulfuric acid doping is not desired (as discussed below). The use of these three methods allowed the study of film electrical properties depending on the residual acid level.

### Example 11

SWNT and DWNT films displayed distinguishable morphologies (FIG. 8). Under cross polarized light (FIG. 8B), no ordered structure was observed in SWNT films coated at low speed (1-2 mm/min), whereas small birefringent regions are observable in films coated at higher speed (3 mm/min) Conversely, all DWNT films showed elongated birefringent domains aligned along the coating direction at all concentrations. This morphology is consistent with the microstructure of the coating solutions and the action of the shear field. In isotropic SWNT solutions, at low speed, the shear rate was insufficient to produce ordering in the films, whereas some shear-induced ordering was observed at high speed. Conversely, the pre-existing liquid crystalline domains in the DWNT solutions were stretched and aligned by the shear field.

### Example 12

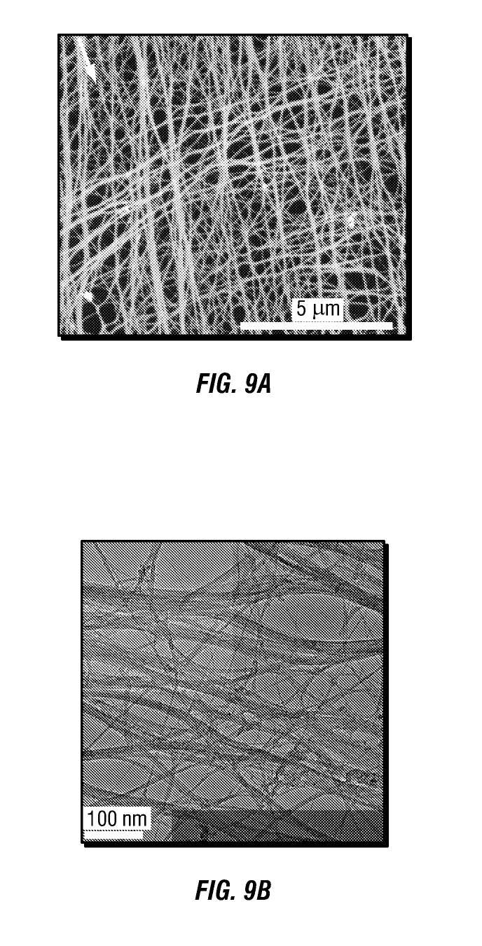

Due to the CNT orientation, the DWNT films were expected to display anisotropic electrical properties. Sheet resistance was measured with a linear four-point probe at three different angles with respect to the coating direction and found no angular variation irrespective of the CSA removal technique (for example, a typical method (1) film had 117.0±12.6 Ω/sq, 117.8±11.4 Ω/sq, and 118.3±8.0 Ω/sq at 0°, 45°, and 90°, respectively at ˜85% transmittance). Further study of the film morphology (FIG. 9) using Scanning Electron Microscope (SEM) and Transmission Electron Microscope (TEM) showed large bundles aligned along the coating direction (responsible for the optical birefringence) connected through a network of thinner bundles and individual CNTs predominantly aligned perpendicular to the large bundles. These perpendicular structures ensure isotropic film conductivity. They may arise from the isotropic phase present in the solution or be induced by vorticity aligning in the shear flow (known to occur in liquid crystalline polymers and CNT fluids).

### Example 13

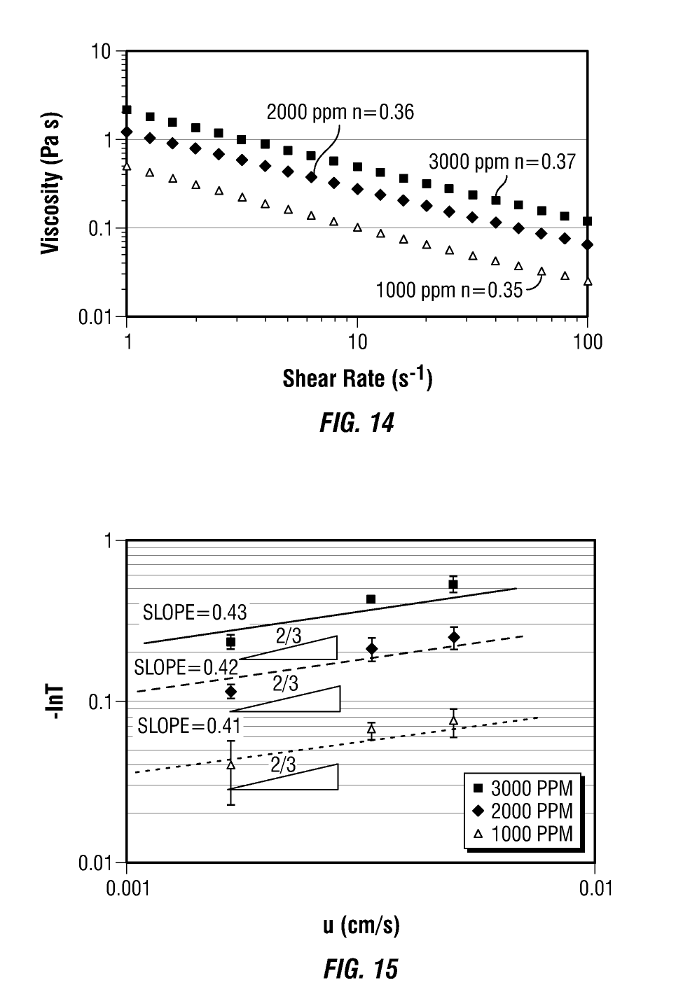

The thickness, h_{wet}, of the dip coated liquid film, called the wet film thickness, is controlled by the interplay of surface tension and gravity, which oppose film formation, and viscous forces, which draw liquid from the coating bath onto the substrate. Whereas surface tension and gravity are process-independent, viscous forces can be controlled by the withdrawal speed u and solution CNT concentration (which affects viscosity). CNT concentration also affects the dry film thickness through h_{wet}=h_{dry} φ, where φ is the CNT volume fraction in the coating liquid. FIG. 4 shows how transmittance and sheet resistance (both related to the dry film thickness) change with withdrawal speed at different DWNT concentrations. As expected, higher withdrawal speed and higher CNT concentration yield thicker films (lower transmittance and lower sheet resistance). For Newtonian fluids, the relationship of wet film thickness to process parameters (the well-known Landau-Levich relation) is a function of the capillary number (ratio of viscous to surface tension forces), or, in terms of velocity, h_{wet}˜u^{2/3}. However, CNT solutions in CSA are non-Newtonian. In the range of measurements, they shear thin as power-law fluids with apparent viscosity ηₐ=K\dot{γ}ⁿ⁻¹, where \dot{γ} is the shear rate, n is the power law exponent (n=1 is a Newtonian fluid), and K is the consistency index (see rheology measurements in FIG. 14). Gutfinger and Tallmadge extended the Landau-Levich model to power-law fluids, obtaining

$${h}_{wet} ∝ {u}^{\frac{2 n}{2 n + 1}} .$$

Applicants' film thickness data (FIG. 15) is closer to the Newtonian behavior, probably due to the low shear rate at which the films are produced (shear thinning may influence the films produced at higher velocity).

### Example 14

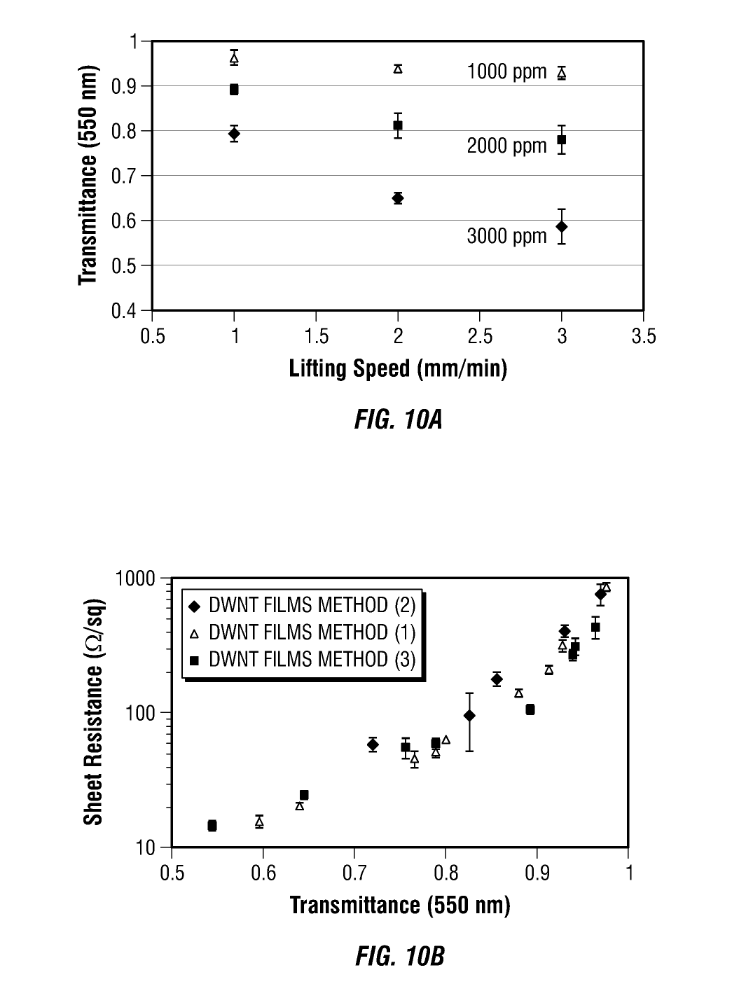

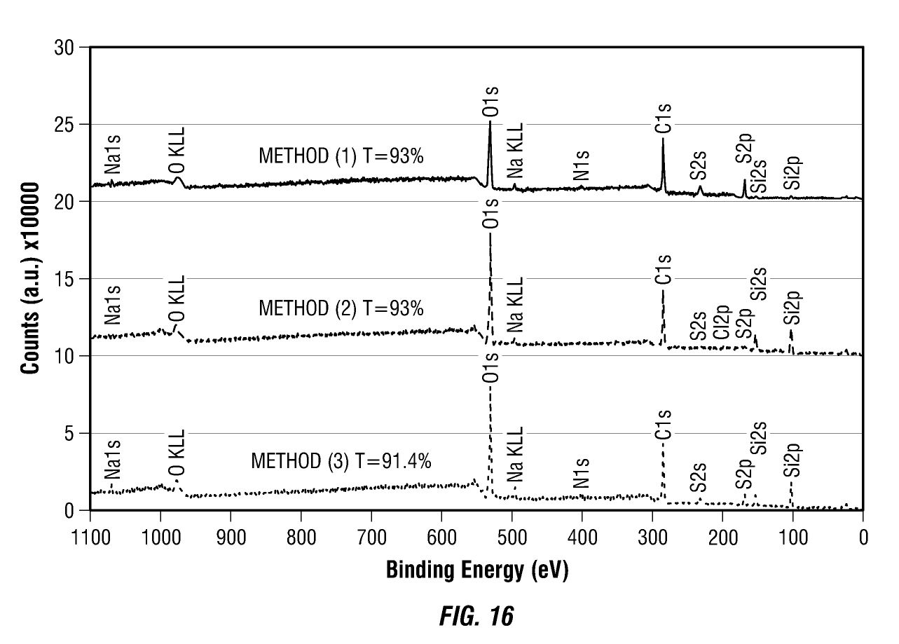

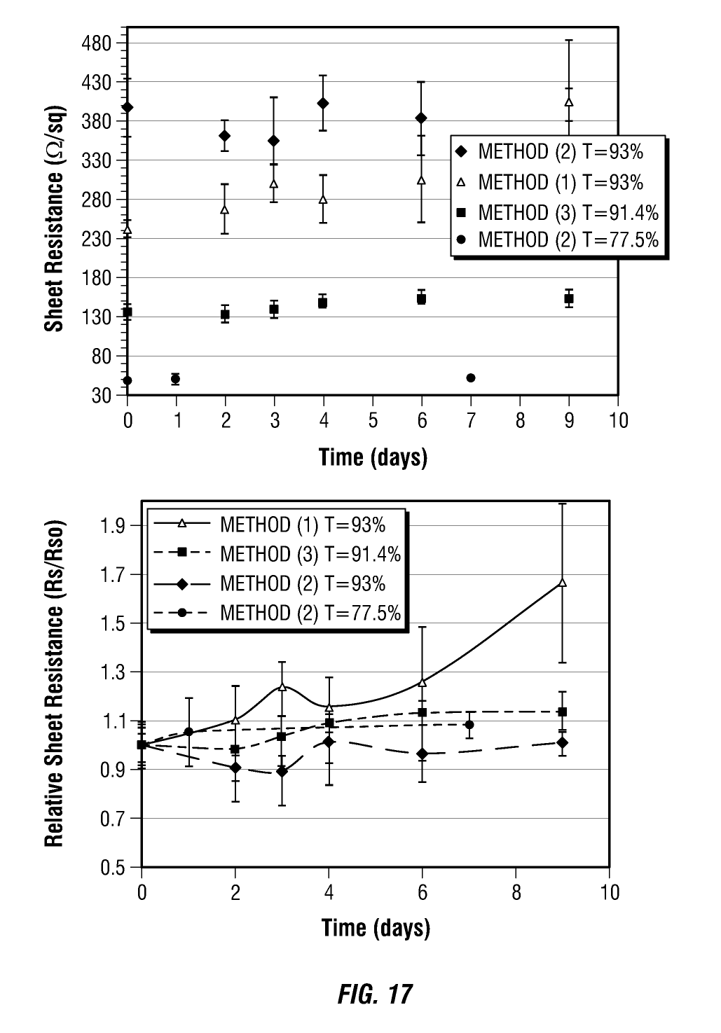

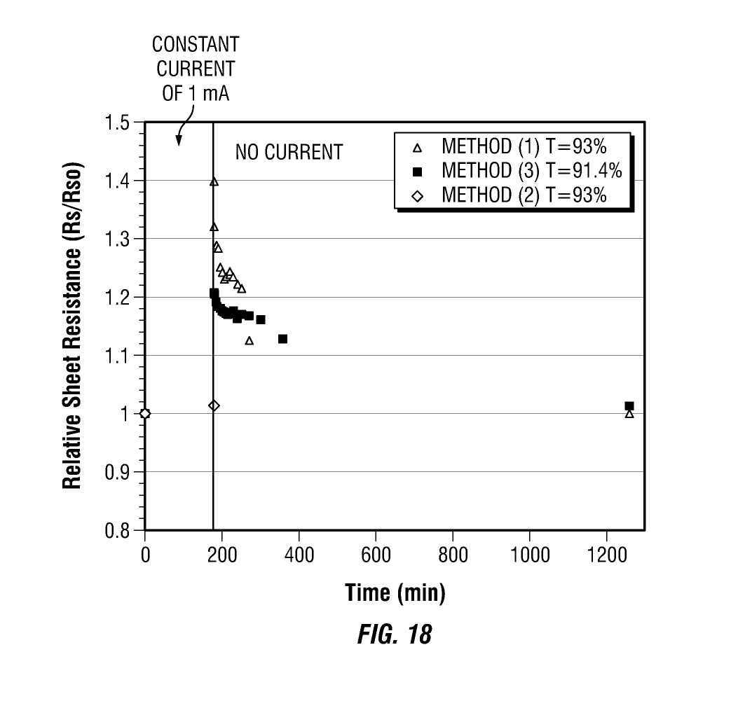

FIG. 10B shows sheet resistance versus transmittance. As expected, thicker films (lower transmittance) exhibit better electrical properties due to the increased number of pathways that the electrons can travel through. All the data fall on the same process curve spanning ˜2 orders of magnitude in sheet resistance, indicating that this simple coating process is very robust and versatile. Interestingly, film electrical properties depend on the fabrication technique used: the best electrical properties were obtained with films made by direct CSA evaporation and diethyl ether wash (method (3)), followed by chloroform coagulated films (method (1)) and water washed films (method (2)). The difference in electrical properties using the three techniques is related to the presence of sulfuric acid (H₂SO₄) that can be completely or partially removed from the film depending on the washing procedure. CSA reacts with the moisture in the air, leading to the formation of sulfuric acid that acts as a doping agent. Complete sulfuric acid removal was achieved by washing the films in water (method (2)), while some residual sulfuric acid appeared in films produced using method (1) and (3) (<0.1 atomic % for method (2), while method (1) and (3) showed ˜9.1 and 2.3 atomic % in sulfur content, respectively—see X-ray photoelectron spectroscopy (XPS) data in FIG. 16). Despite the higher sulfuric acid content, method (3) yielded films with time stability comparable to method (2) (less than 14% variation in 9 days), whereas films fabricated by method (1) showed increasing sheet resistance with time (see FIG. 17). Such results are unexpected because films made by method (3) contain sulfur and are about twice more conductive than films made by method (2). Interestingly, films made by method (1) and (3) showed a rapid increase in sheet resistance (˜40 and 21%, respectively) when a constant current of 1 mA was applied. This increase was reversible and is likely related to ionic conductivity due to residual sulfuric acid in the film (see FIG. 18).

### Example 15

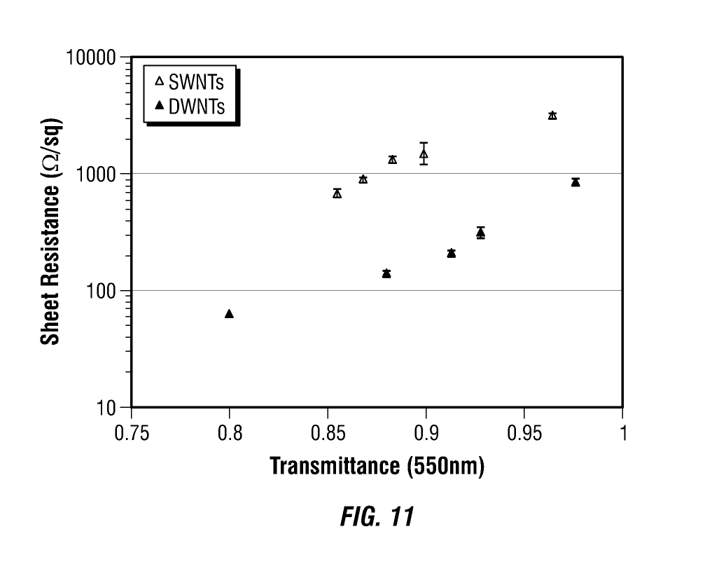

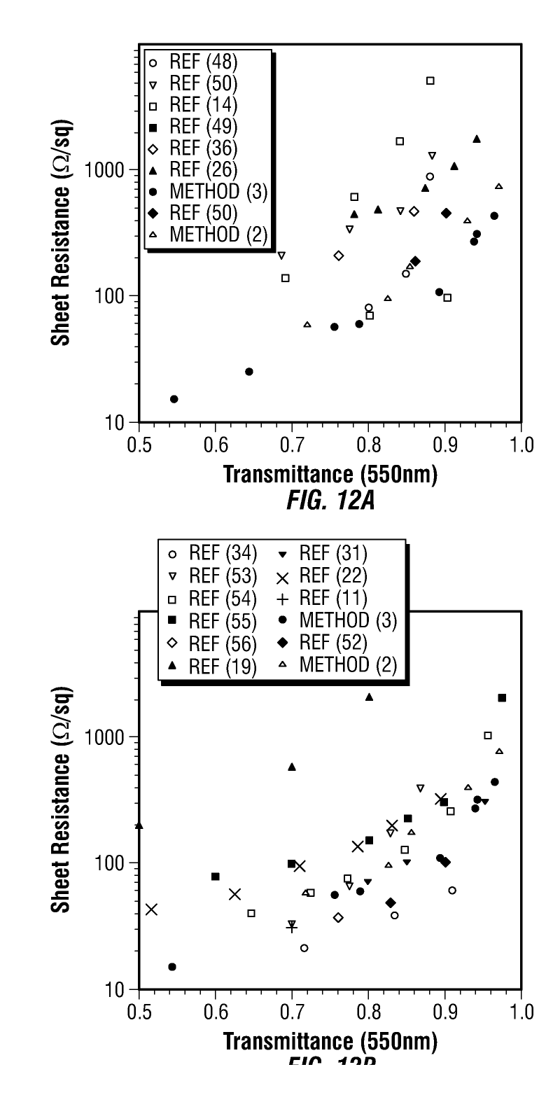

Films fabricated from different CNTs are expected to exhibit different performance due to the respective quality, length, and diameter of the constituent CNTs. Although long CNTs are more difficult to disperse in liquids, they are desirable because the film conductivity scales as L^{1.46}, where L is the average CNT length. When using CSA, length is not a barrier to dissolution. Comparing films made of SWNT and DWNT; within the same fabrication method, SWNT films had ˜4 to ˜10 times higher sheet resistance than corresponding DWNT films (FIG. 11), demonstrating the importance of the length and quality of CNTs for producing high-performance films; for example (method (1)), at ˜88% transmittance, SWNT and DWNT films have a sheet resistance of ˜1300 Ω/sq and 140 Ω/sq, respectively, while at ˜97% transmittance, SWNT and DWNT films have a sheet resistance of ˜3200 Ω/sq and 850 Ω/sq.

### Example 16

Compared to CNT films in the dip-coating literature (FIG. 12A), the films from CSA-CNT solutions show optimal properties, likely due to the CNT length and quality as well as film morphology. FIG. 6B compares findings of the present disclosure using method (2) and (3) with the best values published in literature to date using various techniques. The best performance was obtained by Hecht et al., who made DWNT films by filtration from CSA solutions, but reported short-term stability issues. The ˜2× performance difference may be due to the absence of liquid crystalline domains in their low-concentration (˜100 ppm) solutions, indicating that further improvements may be attained by moving from dip coating to pre-metered coating methods (which can operate at lower solid concentration and lower viscosity). Without any chemical post-treatment, the films show similar properties to those obtained by post-treatments with either nitric acid (HNO₃) or thionyl chloride (SOCl₂), known to dramatically improve the film properties by doping but also give poor electrical stability in time.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method for fabricating carbon nanotube films comprising the steps of:
(i) suspending carbon nanotubes in a superacid to form a dispersed carbon nanotube-superacid solution, wherein the carbon nanotubes have substantially exposed sidewalls in the carbon nanotube-superacid solution;
(ii) applying the dispersed carbon nanotube-superacid solution onto a surface to form a carbon nanotube film on the surface; and
(iii) removing the superacid.

2. The method of claim 1, wherein the carbon nanotubes are selected from the group consisting of single-wall carbon nanotubes, double-wall carbon nanotubes, multi-wall carbon nanotubes, small diameter carbon nanotubes, ultra-short carbon nanotubes, and combinations thereof.

3. The method of claim 1, wherein the superacid is selected from the group consisting of fuming sulfuric acid, chlorosulfonic acid, oleum, triflic acid, fluorosulfonic acid, trifluoromethanesulfonic acid, perchloric acid, anhydrous hydrogen fluoride, and combinations thereof.

4. The method of claim 1, wherein the superacid comprises chlorosulfonic acid.

5. The method of claim 1, wherein the carbon-nanotube superacid solution further comprises high performance materials selected from the group consisting of graphene, fullerenes, boron nitride nanotubes, hexagonal boron nitride, and combinations thereof.

6. The method of claim 1, wherein the suspending step comprises the use of unfunctionalized carbon nanotubes.

7. The method of claim 1, wherein the formed carbon nanotube-superacid solution is an isotropic solution, and wherein the isotropic solution comprises individually dispersed carbon nanotubes.

8. The method of claim 1, wherein the formed carbon nanotube-superacid solution is a biphasic solution, and wherein the biphasic solution comprises a mixture of both individually dispersed carbon nanotubes and liquid crystals of aligned carbon nanotubes.

9. The method of claim 1, wherein the formed carbon nanotube-superacid solution is in liquid crystalline form.

10. The method of claim 1, wherein the applying step is selected from the group consisting of filtration, printing, casting, coating, dip coating, die coating, rod coating, spray coating, slot coating, gravure coating, slide coating, knife coating, air knife coating, curtain coating, screen coating, and combinations thereof.

11. The method of claim 1, wherein the applying step comprises dip coating.

12. The method of claim 1, wherein the surface is selected from the group consisting of aluminosilicates, silicates, silicon oxides, zeolites, glass, quartz, polymers, and combinations thereof.

13. The method of claim 1, wherein the surface comprises a polymer.

14. The method of claim 13, wherein the polymer is selected from the group consisting of polyethylenes, polyethylene terephthalate, polypropylenes, polystyrenes, polyethylene furanoate, polycyclohexylenedimethylene terephthalate, polytetrafluoroethylene, fluorinated ethylene propylene, perfluoroalkoxy, polyamides, polyimides, epoxies, aramids, polyacrylonitriles, polyvinyl alcohols, polybutadienes, poly acrylic acids, poly lactic acids, poly methacrylic acids, polymethyl methacrylates, polyurethanes, poly vinyl chlorides, polydimethyloxanes, polycarbonates, and combinations thereof.

15. The method of claim 1, wherein the removing step is selected from the group consisting of direct coagulation, addition of polymers, direct evaporation, and combinations thereof.

16. The method of claim 1, wherein the removing step occurs by direct coagulation, and wherein the direct coagulation comprises dipping the carbon nanotube film in pure solvents or mixtures of solvents.

17. The method of claim 16, wherein the solvent comprises chloroform, isopropanol, ether, acetone, and combinations thereof.

18. The method of claim 16, wherein the removing step further comprises heating by oven drying, exposure to hot gas, microwaving, or combinations thereof.

19. The method of claim 16, wherein the removing step further comprises washing with diethyl ether followed by water.

20. The method of claim 1, wherein the carbon nanotube film has a thickness of about 1 nm to about 100 nm.

21. The method of claim 1, wherein the carbon nanotube film has a thickness of about 10 nm to about 20 nm.

22. The method of claim 1, wherein the carbon nanotube film has an average transmittance of about 60% to about 100% at 550 nm.

23. The method of claim 1, wherein the carbon nanotube film has an average sheet resistance of about 20 ohm/sq to about 1530 ohm/sq.

24. The method of claim 1, wherein the carbon nanotube film is used as a coating for a touch screen.

25. The method of claim 1, wherein the carbon nanotube film comprises individualized carbon nanotubes.

26. The method of claim 1, wherein the carbon nanotube film comprises long carbon nanotubes, wherein the long carbon nanotubes comprise lengths that range from about 5 μm to about 20 μm.

27. The method of claim 1, wherein the carbon nanotube film comprises isotropically oriented carbon nanotubes.

28. The method of claim 1, wherein the carbon nanotube film comprises bundles of aligned carbon nanotubes.

29. The method of claim 1, wherein the carbon nanotube film comprises a mixture of isotropically oriented carbon nanotubes and bundles of aligned carbon nanotubes.

30. The method of claim 29, wherein the carbon nanotube film has a conductivity range from about 1.1×10⁵ S/m to about 3.1×10⁵ S/m.

31. The method of claim 29, wherein the carbon nanotube film has a conductivity range from about 2.5×10⁵ S/m to about 5.5×10⁶ S/m.

32. The method of claim 29, wherein the liquid crystals of aligned carbon nanotubes have an ellipsoidal shape.

33. The method of claim 29, wherein the liquid crystals of the aligned carbon nanotubes are thread-like.

34. The method of claim 1, wherein the method occurs without the utilization of carbon nanotube wrapping molecules.

35. The method of claim 1, wherein the method occurs without the utilization of sonication.

36. The method of claim 1, further comprising a step of separating the carbon nanotube film from the surface.

37. A carbon nanotube film comprising a plurality of carbon nanotubes, wherein the carbon nanotubes are dispersed and individualized.

38. The carbon nanotube film of claim 37, wherein the carbon nanotube film is freestanding.

39. The carbon nanotube film of claim 37, wherein the carbon nanotube film is immobilized onto a surface.

40. The carbon nanotube film of claim 39, wherein the surface is selected from the group consisting of aluminosilicates, silicates, silicon oxides, zeolites, glass, quartz, polymers, and combinations thereof.

41. The method of claim 39, wherein the surface comprises a polymer.

42. The method of claim 41, wherein the polymer is selected from the group consisting of polyethylenes, polyethylene terephthalate, polypropylenes, polystyrenes, polyethylene furanoate, polycyclohexylenedimethylene terephthalate, polytetrafluoroethylene, fluorinated ethylene propylene, perfluoroalkoxy, polyamides, polyimides, epoxies, aramids, polyacrylonitriles, polyvinyl alcohols, polybutadienes, poly acrylic acids, poly lactic acids, poly methacrylic acids, polymethyl methacrylates, polyurethanes, poly vinyl chlorides, polydimethyloxanes, polycarbonates, and combinations thereof.

43. The carbon nanotube film of claim 39, wherein the surface is patterned, grooved, or non-planar.

44. The carbon nanotube film of claim 37, wherein the carbon nanotubes are selected from the group consisting of single-walled carbon nanotubes, double-walled carbon nanotubes, multi-walled carbon nanotubes, small diameter carbon nanotubes, ultra-short carbon nanotubes, and combinations thereof.

45. The carbon nanotube film of claim 37, wherein the film further comprises high performance materials selected from the group consisting of graphene, fullerenes, boron nitride nanotubes, hexagonal boron nitride, and combinations thereof.

46. The carbon nanotube film of claim 37, wherein the carbon nanotube film comprises isotropically oriented carbon nanotubes.

47. The carbon nanotube film of claim 37, wherein the carbon nanotube film comprises bundles of aligned carbon nanotubes.

48. The carbon nanotube film of claim 37, wherein the carbon nanotube film contains a mixture of isotropically oriented carbon nanotubes and bundles of aligned carbon nanotubes.

49. The carbon nanotube film of claim 48, wherein the bundles of aligned carbon nanotubes have an ellipsoidal shape.

50. The carbon nanotube film of claim 37, wherein the carbon nanotubes comprise long carbon nanotubes, wherein the long carbon nanotubes comprise lengths that range from about 5 μm to about 20 μm.

51. The carbon nanotube film of claim 37, wherein the carbon nanotube film has a thickness of about 1 nm to about 100 nm.

52. The carbon nanotube film of claim 37, wherein the carbon nanotube film has a thickness of about 10 nm to about 20 nm.
